(19) United States
(12) Patent Application Publication
(10) Pub. No.: US 2024/0354676 A1
(43) Pub. Date: Oct. 24, 2024

(54) SERVICE CAPABILITY PREDICTION AND PROVISIONING

(71) Applicant: HSBC Group Management Services Limited, London (GB)

(72) Inventor: Ashwath Kadur Ramaswamy, Hyderabad (IN)

(21) Appl. No.: 18/648,011

(22) Filed: Apr. 26, 2024

(51) Int. Cl. G06Q 10/0631; G06Q 30/018; G06Q 30/0202; G06Q 40/03

(52) U.S. Cl. CPC G06Q 10/06315; G06Q 30/018; G06Q 30/0202; G06Q 40/03

(57) ABSTRACT

At least one processor may predict a customer demand for a resource using a first machine learning (ML) model, predict a resource availability for the resource using a second ML model, predict a resource capability for the resource using a third ML model, and predict a process capability for the resource using a fourth ML model. The at least one processor may determine a gap between the customer demand and a resource ability to meet the customer demand exists due to a combination of the resource availability, the resource capability, and the process capability. The at least one processor may adjust at least one resource parameter to reduce or eliminate the gap.

### BACKGROUND

Predicting the capability to service customers plays a pivotal role in ensuring technical and operational efficiency, customer satisfaction, and overall business success. The ability to anticipate, innovate, and meet customer needs in a timely manner is relevant for various industries and applications. Failure to accurately predict demand could result in overcommitting resources, including technical resources, leading to increased operational costs and potential dissatisfaction among customers due to delays or inadequate service. Furthermore, an inability to meet customer demands also attracts regulatory attention to financial institutions and has a potential to impact the economic well-being of customers and service providers alike.

### SUMMARY OF THE DISCLOSURE

Some embodiments described herein may provide a method comprising predicting, by at least one processor, a customer demand for a resource using a first machine learning (ML) model; predicting, by the at least one processor, a resource availability for the resource using a second ML model; predicting, by the at least one processor, a resource capability for the resource using a third ML model; predicting, by the at least one processor, a process capability for the resource using a fourth ML model; determining, by the at least one processor, a gap between the customer demand and a resource ability to meet the customer demand exists due to a combination of the resource availability, the resource capability, and the process capability; and adjusting, by the at least one processor, at least one resource parameter to reduce or eliminate the gap.

Some embodiments described herein may provide a system comprising at least one processor and at least one non-transitory memory in communication with the at least one processor and storing instructions that, when executed by the at least one processor, cause the at least one processor to perform processing. The processing may comprise predicting a customer demand for a resource using a first machine learning (ML) model; predicting a resource availability for the resource using a second ML model; predicting a resource capability for the resource using a third ML model; predicting a process capability for the resource using a fourth ML model; determining a gap between the customer demand and a resource ability to meet the customer demand exists due to a combination of the resource availability, the resource capability, and the process capability; and adjusting at least one resource parameter to reduce or eliminate the gap.

In some embodiments, the predicting the customer demand may comprise collecting, by the at least one processor, first data indicative of at least one customer trait; creating, by the at least one processor, first ML input data by transforming at least a portion of the first data; and processing, by the at least one processor, the first ML input data with the first ML model. In some embodiments, the predicting the customer demand may further comprise evaluating, by the at least one processor, a quality of the first data; and adjusting, by the at least one processor, an output of the processing of the first ML model according to the quality.

In some embodiments, the method may further comprise training the first ML model by performing processing comprising collecting, by the at least one processor, first training data indicative of at least one customer trait; creating, by the at least one processor, first ML input training data by transforming at least a portion of the first training data; dividing, by the at least one processor, the first ML input training data into a training set and a testing set; training, by the at least one processor, the first ML model on the training set; and testing, by the at least one processor, the first ML model by processing the testing set with the first ML model.

In some embodiments, the predicting the resource availability may comprise collecting, by the at least one processor, second data indicative of at least one resource characteristic; evaluating, by the at least one processor, a quality of the second data; selecting, by the at least one processor, a statistical model according to the quality as the second ML model; and processing, by the at least one processor, the second data with the second ML model.

In some embodiments, the predicting the resource capability may comprise collecting, by the at least one processor, intrinsic third data indicative of at least one intrinsic resource characteristic; collecting, by the at least one processor, extrinsic third data indicative of at least one extrinsic resource characteristic; evaluating, by the at least one processor, a quality of the intrinsic third data and the extrinsic third data; selecting, by the at least one processor, a statistical model according to the quality as the third ML model; and processing, by the at least one processor, the intrinsic third data and the extrinsic third data with the third ML model.

In some embodiments, the predicting the process capability may comprise collecting, by the at least one processor, fourth data indicative of at least one process characteristic; evaluating, by the at least one processor, a quality of the fourth data; selecting, by the at least one processor, a statistical model according to the quality as the fourth ML model; and processing, by the at least one processor, the fourth data with the fourth ML model.

In some embodiments, the determining the gap may comprise processing, by the at least one processor, the resource availability, the resource capability, and the process capability with a fifth ML model.

In some embodiments, the adjusting may comprise increasing a number of components assigned to the resource. In some embodiments, the adjusting may comprise reporting an explanation of the gap.

### BRIEF DESCRIPTIONS OF THE DRAWINGS

FIG. 1 shows an example prediction and provisioning system according to some embodiments of the disclosure.

FIG. 2 shows an example prediction and provisioning process according to some embodiments of the disclosure.

FIG. 3 shows an example demand prediction process according to some embodiments of the disclosure.

FIG. 4 shows an example resource availability projection process according to some embodiments of the disclosure.

FIG. 5 shows an example resource capability projection process according to some embodiments of the disclosure.

FIG. 6 shows an example process capability projection process according to some embodiments of the disclosure.

FIG. 7 shows an example integration and prediction process according to some embodiments of the disclosure.

FIGS. 8A-8G show example narration reports according to some embodiments of the disclosure.

FIG. 9 shows an example computing device according to some embodiments of the disclosure.

### DETAILED DESCRIPTION OF SEVERAL EMBODIMENTS

Embodiments described herein can predict service capability in a variety of contexts so that resources can be provisioned accordingly. Predicting the service capability may involve forecasting demand across products and services, managing resources effectively, and/or optimizing customer interactions.

For example, timely and accurate predictions may allow banks and other financial institutions to allocate resources efficiently, streamline their operations, and enhance customer experience. For example, predicting the demand for loans or credit cards may help financial institutions allocate the right amount of technical resources, capital, and staff to meet customer expectations. By leveraging data analytics and machine learning (ML) and/or artificial intelligence (AI), embodiments described herein can analyze customer behaviors, preferences, and/or trends to tailor products and services accordingly. In addition to the technical advantages of customizing and properly provisioning resources, this can enhance customer satisfaction and foster customer loyalty.

The relevance of predicting the servicing capability extends beyond finance and permeates across industries. Each industry may experience challenges and consequences for failing to anticipate customer needs. For example, in a supermarket sector, accurate demand forecasting is crucial to ensure that shelves are stocked with the right products at the right time. Failure to predict and meet the consumer preferences and demand patterns can lead to excess inventory, resulting in increased carrying costs and potential losses due to perishable goods reaching their expiration dates. In the healthcare industry, predicting patient needs can enable optimized resource allocation and provisioning of timely and effective care. Hospitals and healthcare providers must anticipate patient admissions, allocate staff accordingly, and ensure that essential medical supplies are readily available. A failure to predict patient influx can lead to overwhelmed healthcare systems, inadequate staffing levels, and compromised patient care. In another example from the technology industry, some companies can fail to predict the demand for certain products accurately. For instance, shortages of electronic components, such as semiconductor chips, have impacted various industries, including automotive and electronics manufacturing. Companies that failed to anticipate the increased demand for these components found themselves grappling with production delays, increased costs, and lost market opportunities.

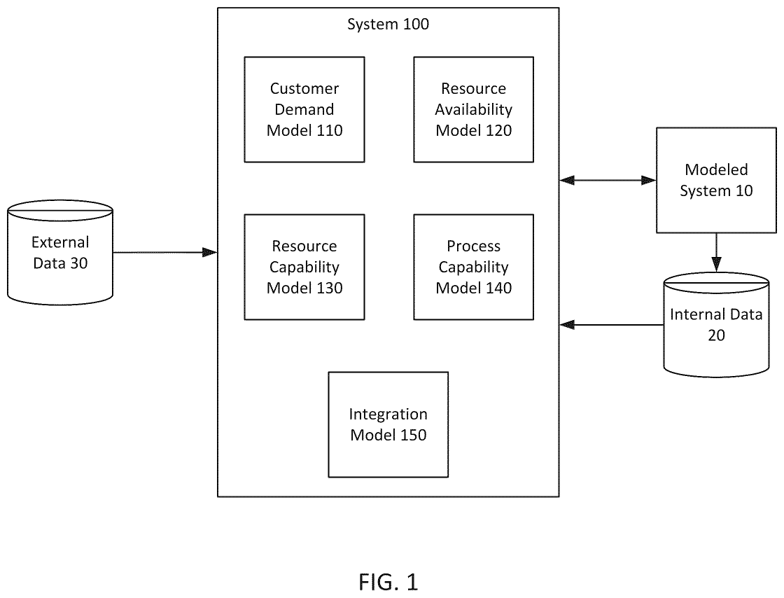

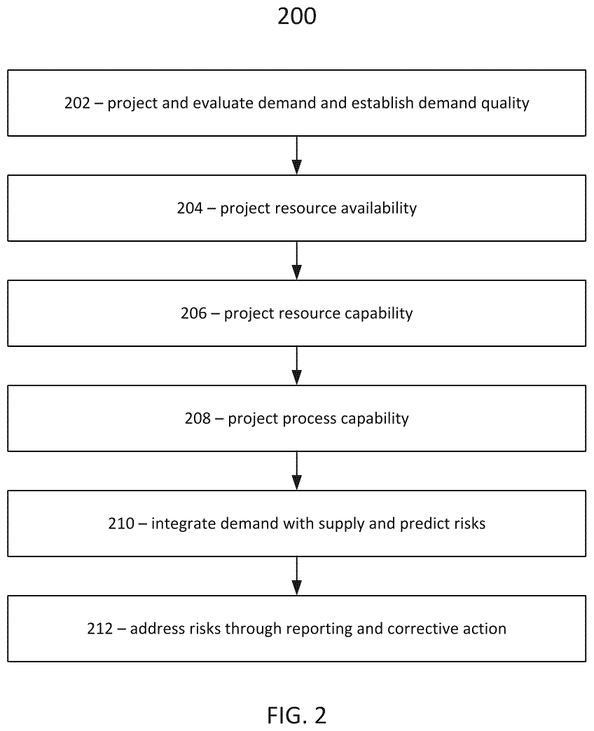

FIG. 1 shows an example prediction and provisioning system 100 according to some embodiments of the disclosure. System 100 can include and/or be configured to operate ML models such as customer demand model 110, resource availability model 120, resource capability model 130, process capability model 140, and/or integration model 150. System 100 may interact with modeled system 10 and/or data sources such as internal data 20 and/or external data 30. Illustrated components may include a variety of hardware, firmware, and/or software components that interact with one another. The elements of FIG. 1 are described in greater detail below, but in general, system 100 may receive data from modeled system 10, internal data 20, and/or external data 30 and process the data to predict service capability of modeled system 10 and/or implement service improvements to modeled system 10. For example, FIGS. 2-8G illustrate the functioning of the illustrated components in detail.

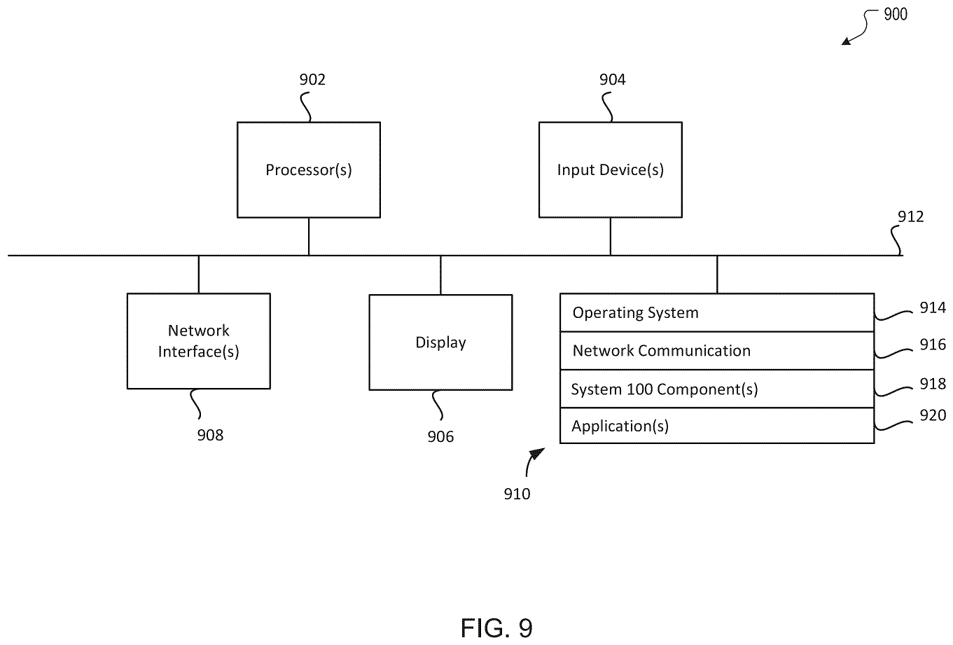

Some components shown in FIG. 1 may communicate with one another using networks. For example, system 100 may obtain data and/or communicate with modeled system 10 through one or more networks (e.g., the Internet, an intranet, and/or one or more networks that provide a cloud environment). In another example, system 100 may use the one or more networks to direct operation of remotely-hosted ML models (e.g., customer demand model 110, resource availability model 120, resource capability model 130, process capability model 140, and/or integration model 150). Each component may be implemented by one or more computers (e.g., as described below with respect to FIG. 9).

Elements illustrated in FIG. 1 (e.g., system 100 including customer demand model 110, resource availability model 120, resource capability model 130, process capability model 140, and/or integration model 150, modeled system 10, internal data 20, and external data 30) are each depicted as single blocks for case of illustration, but those of ordinary skill in the art will appreciate that these may be embodied in different forms for different implementations. For example, system 100 may be a combined hardware, firmware, and/or software element and/or multiple distributed elements. Likewise, modeled system 10 may be a single element or may be distributed among multiple logical and/or physical locations. Also, while one system 100 with five separate ML models, one modeled system 10, one internal data 20, and one external data 30 are illustrated, this is for clarity only, and multiples of any of the above elements may be present. In practice, there may be single instances or multiples of any of the illustrated elements, and/or these elements may be combined or co-located. For example, some embodiments may use the same ML models to model multiple elements, rather than having four separate ML models as shown.

In the following descriptions of how the illustrated components function, several examples are presented, including examples using specific data or data types. However, those of ordinary skill in the art will appreciate that these examples are merely for illustration, and the disclosed embodiments are extendable to other application and data contexts.

FIG. 2 shows an example prediction and provisioning process 200 according to some embodiments of the disclosure. In some embodiments, system 100 can perform process 200 to determine demand for resources and the ability of those resources to meet the demand. In cases where a gap exists between predicted demand and predicted ability, process 200 can include measures that can close the gap.

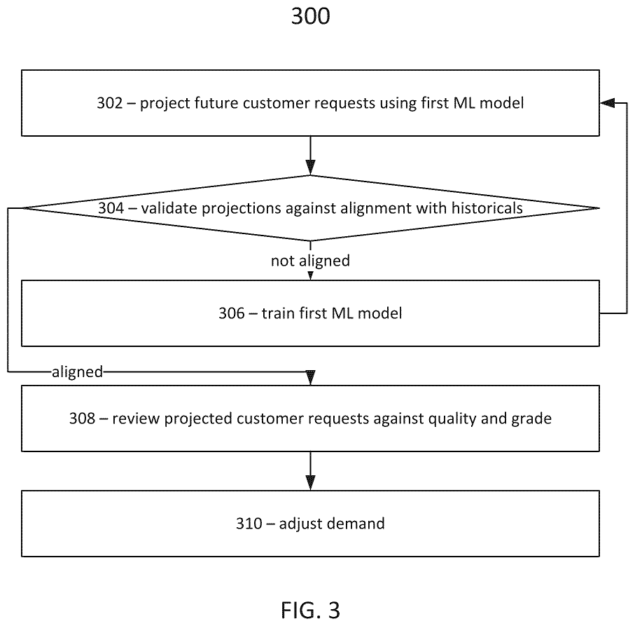

At 202, system 100 may project and evaluate demand and, in at least some embodiments, may establish demand quality. For example, system 100 can predict a customer demand for a resource using a first ML model, such as customer demand model 110. The predicting can include collecting first data indicative of at least one customer trait, for example from modeled system 10, internal data 20, and/or external data 30. The predicting can further include creating first ML input data by transforming at least a portion of the first data and processing the first ML input data with the first ML model. In some embodiments, the predicting can further include evaluating a quality of the first data and adjusting an output of the processing of the first ML model according to the quality. FIG. 3 describes example processing that can project and evaluate demand and/or establish demand quality in detail.

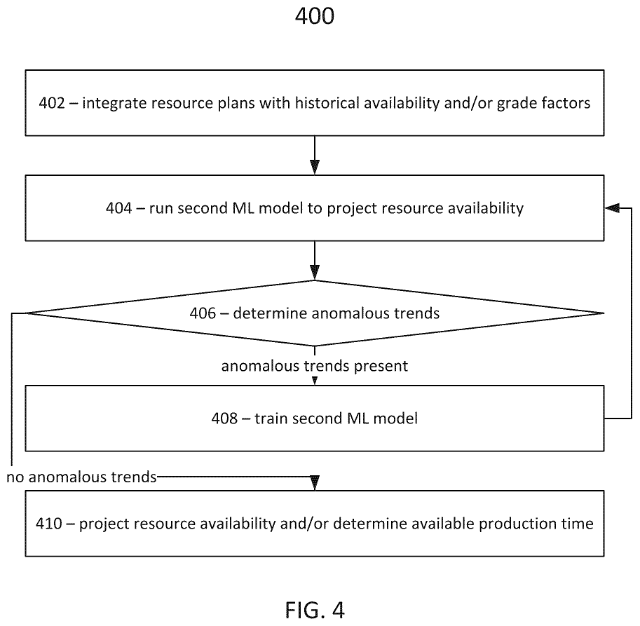

At 204, system 100 may project resource availability. For example, system 100 can predict a resource availability for the resource using a second ML model, such as resource availability model 120. The predicting can include collecting second data indicative of at least one resource characteristic, for example from modeled system 10, internal data 20, and/or external data 30. The predicting can further include evaluating a quality of the second data, selecting a statistical model according to the quality as the second ML model, and processing the second data with the second ML model. FIG. 4 describes example processing that can project resource availability in detail.

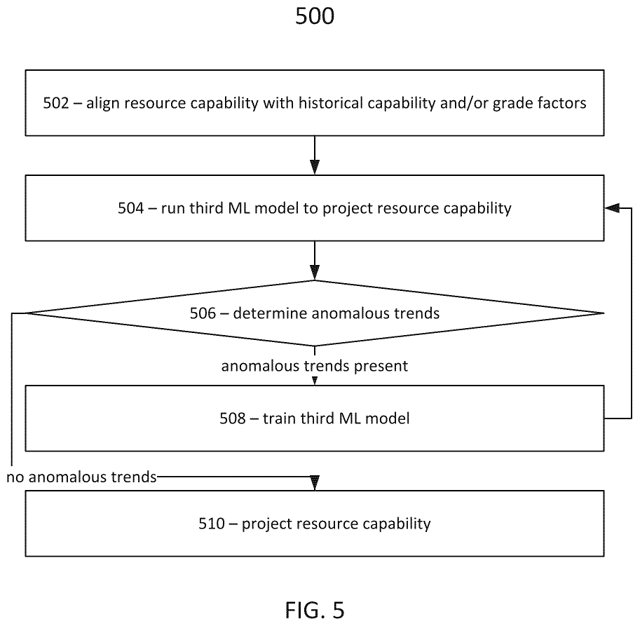

At 206, system 100 may project resource capability. For example, system 100 can predict a resource capability for the resource using a third ML model, such as resource capability model 130. The predicting can include collecting intrinsic third data indicative of at least one intrinsic resource characteristic, for example from modeled system 10 and/or internal data 20, and collecting extrinsic third data indicative of at least one extrinsic resource characteristic, for example from external data 30. The predicting can further include evaluating a quality of the intrinsic third data and the extrinsic third data, selecting a statistical model according to the quality as the third ML model, and processing the intrinsic third data and the extrinsic third data with the third ML model. FIG. 5 describes example processing that can project resource capability in detail.

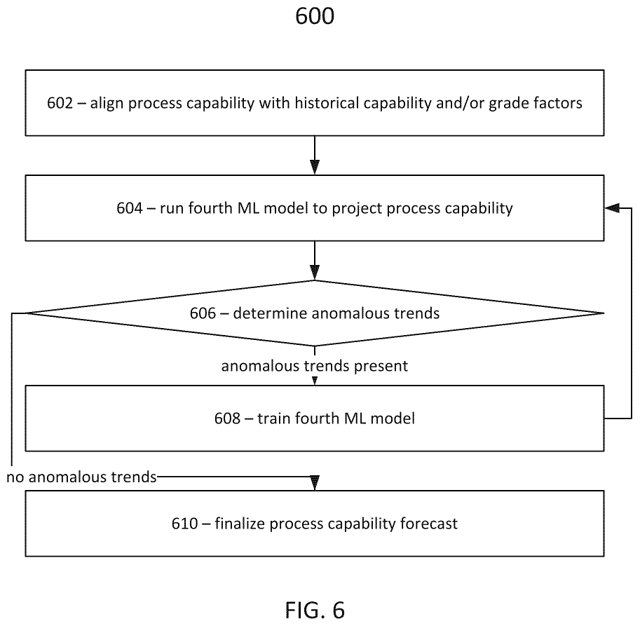

At 208, system 100 may project process capability. For example, system 100 can predict a process capability for the resource using a fourth ML model, such as process capability model 140. The predicting can include collecting fourth data indicative of at least one process characteristic, for example from modeled system 10, internal data 20, and/or external data 30. The predicting can further include evaluating a quality of the fourth data, selecting a statistical model according to the quality as the fourth ML model, and processing the fourth data with the fourth ML model. FIG. 6 describes example processing that can project process capability in detail.

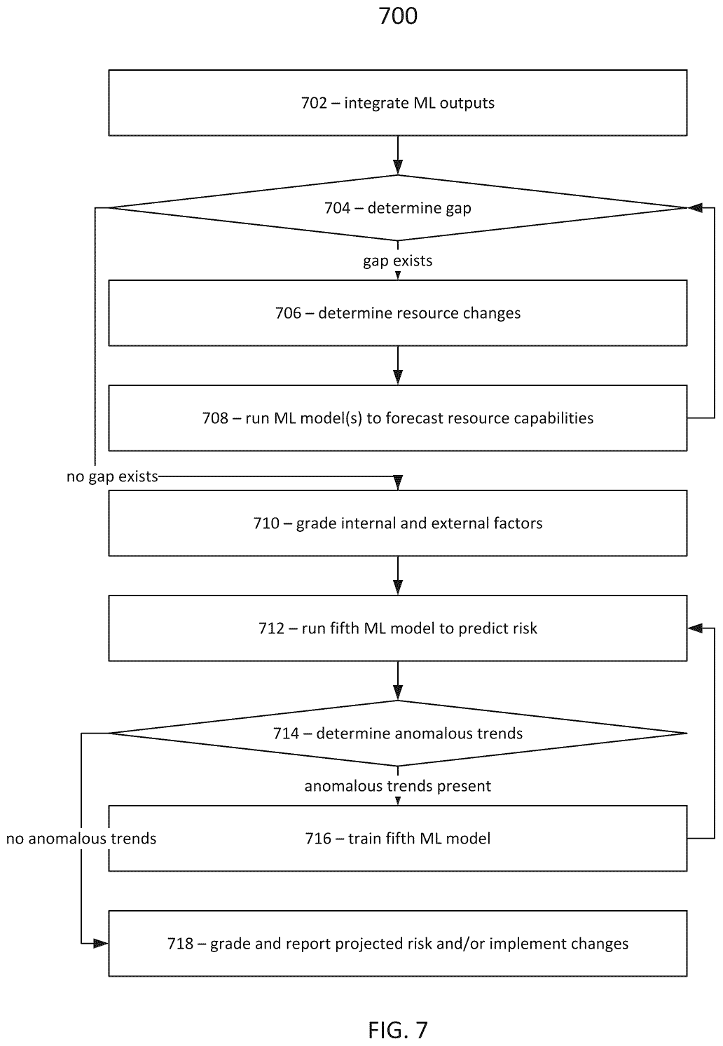

At 210, system 100 may integrate demand with supply and predict risks. For example, system 100 can determine a gap between the customer demand and a resource ability to meet the customer demand exists due to a combination of the resource availability, the resource capability, and the process capability. In some embodiments, determining the gap can include processing the resource availability, the resource capability, and the process capability with a fifth ML model, such as integration model 150. FIG. 7 describes example processing that can integrate demand with supply and/or predict risks in detail.

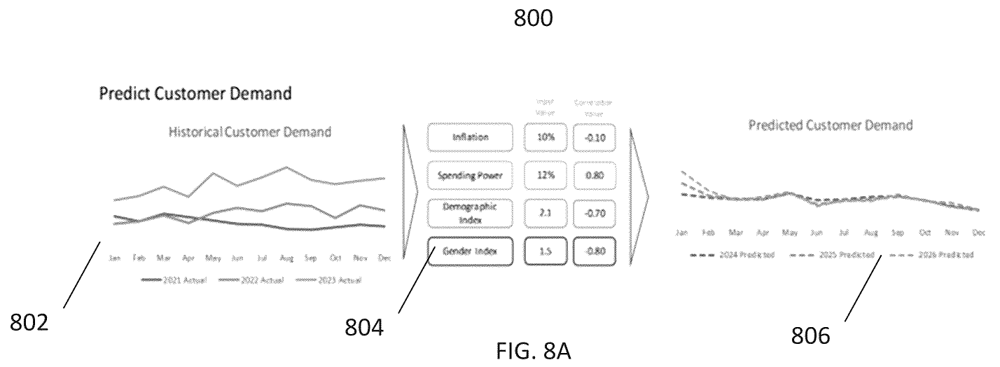

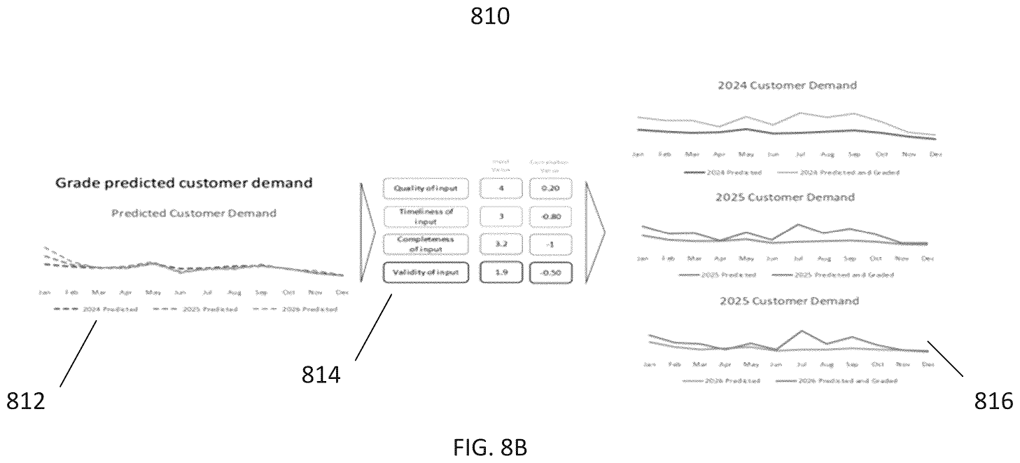

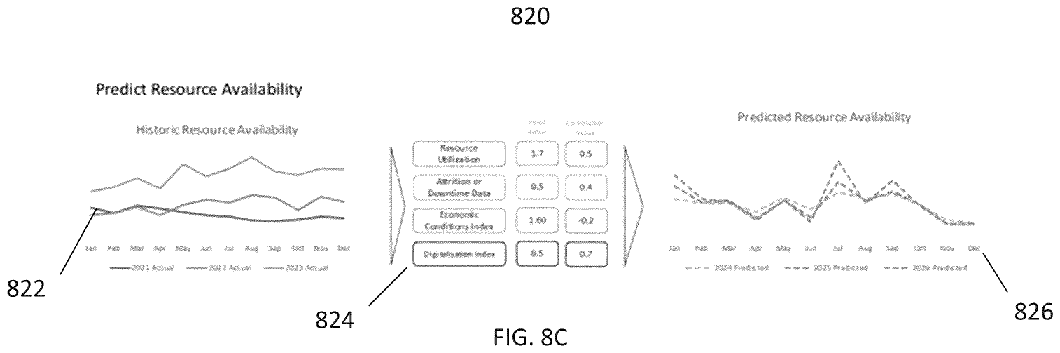

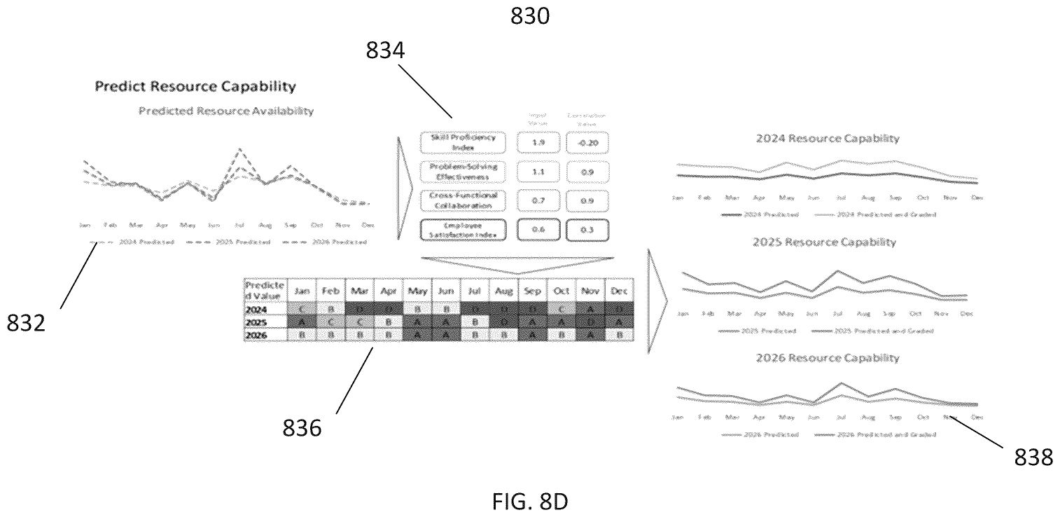

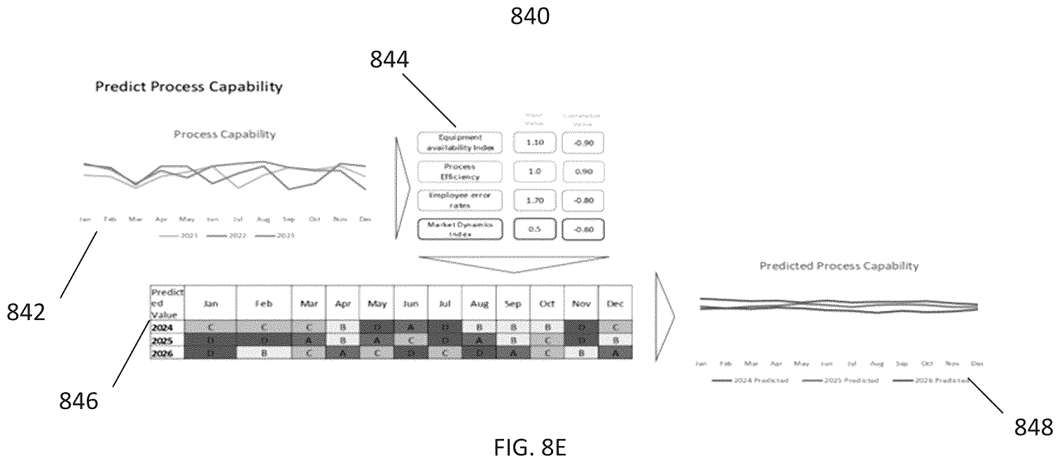

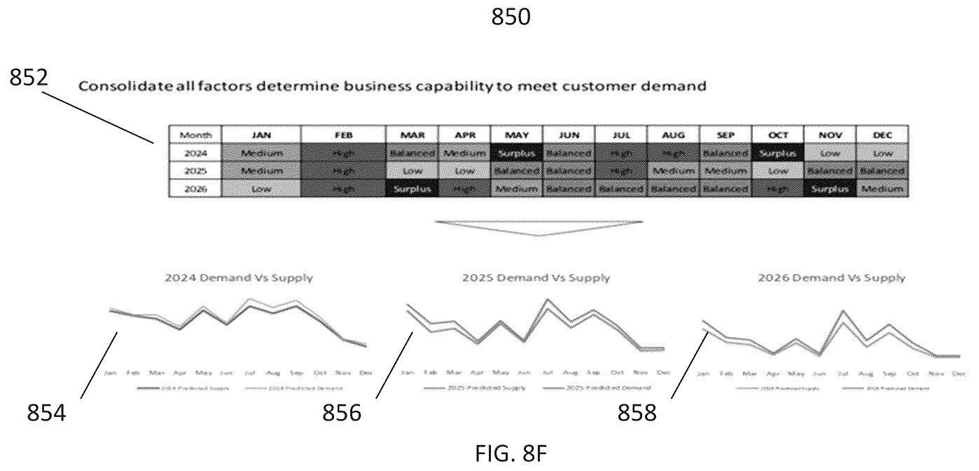

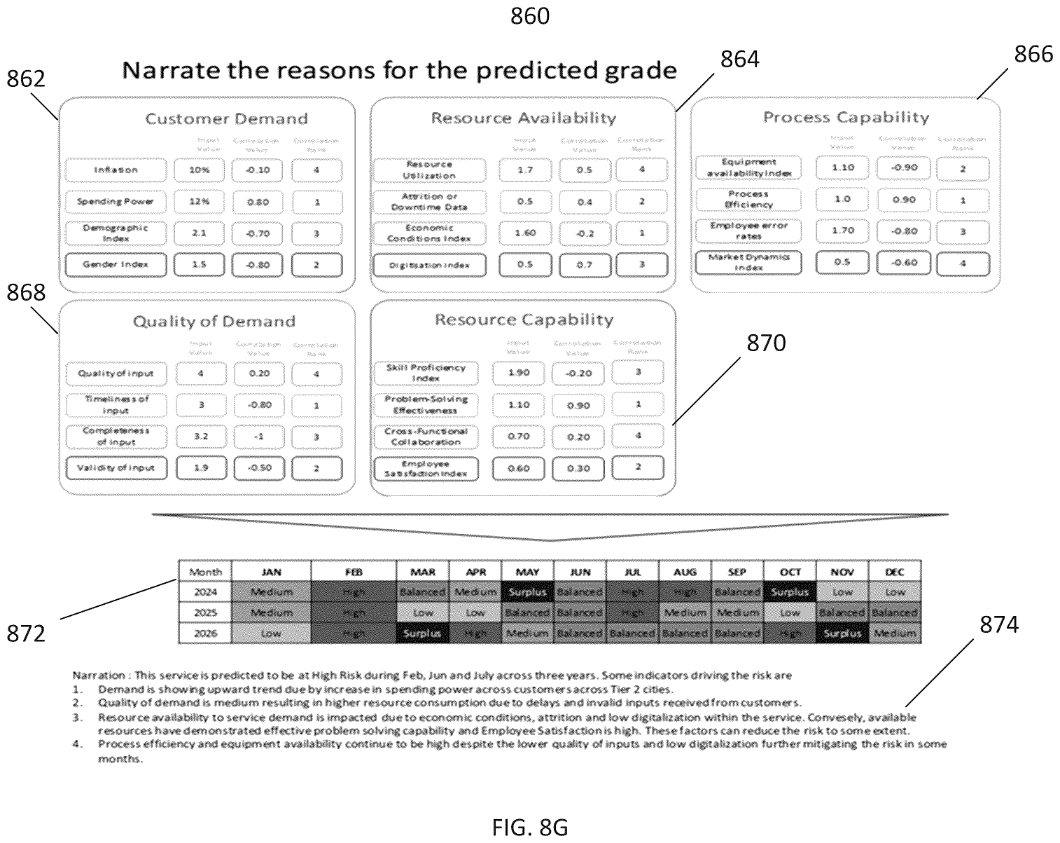

At 212, system 100 may address risks through reporting and corrective action. For example, system 100 can adjust at least one resource parameter of modeled system 10 to reduce or eliminate the gap. In some embodiments, the adjusting may include increasing a number of components assigned to the resource and/or otherwise altering properties of modeled system 10. In some embodiments, the adjusting may include reporting an explanation of the gap and/or other data. FIG. 8 describes example processing that can address risks through reporting and/or corrective action in detail.

In general, the ML models used in process 200, such as the first, second, third, and fourth ML models, can be built according to the following working principles, with specific details about building the respective models given below. The following broad algorithm may form the working principle on which ML models may be built.

System 100 may first collect and prepare data. This can include gathering historical data from various sources such as transaction records, customer profiles, inquiries, and product usage. System 100 may collect data for objective metrics and/or supporting factors. System 100 may clean the data, handle missing values, and/or ensure data consistency.

System 100 may review metrics and their dynamics with each other and objective metrics. System 100 may identify relevant metrics such as average turnaround time, first time resolution, transaction history, products owned, geographic location, etc. System 100 may create new features that may help in understanding customer behavior, such as transaction frequency, average transaction amount, or the length of the customer relationship with the institution, for example.

System 100 may perform segmentation, such as grouping customers based on similarities, using clustering techniques (e.g., K-means) to identify customer segments and/or segmenting customers based on their financial behavior, needs, and preferences.

System 100 may perform model selection and training. System 100 may choose appropriate ML models like regression, classification, or recommendation systems depending on the prediction task. System 100 may train models using historical data, for example to predict customer requests. Some potential models may include, but are not limited to, regression models to predict numerical values (e.g., predicting loan amounts), classification models to predict categorical outcomes (e.g., predicting product preferences), and/or collaborative filtering or content-based recommendation systems for suggesting suitable products based on past behaviors.

System 100 may perform model evaluation and validation. System 100 may split the data into training and testing sets to assess model performance. System 100 may use evaluation metrics such as accuracy, precision, recall, or F1-score, depending on the prediction task. System 100 may perform cross-validation to ensure the model's robustness and generalizability.

System 100 may perform predictive analysis and deployment. System 100 can apply the trained model to new customer data to predict their potential requests or needs and/or integrate the prediction models within the organization's systems or platforms to provide real-time suggestions or anticipate customer requirements.

System 100 may perform continuous improvement and/or monitoring. System 100 can regularly update and retrain models with new data to keep them up to date and/or monitor model performance and customer feedback to enhance predictions and ensure they align with customer expectations.

System 100 may implement data privacy considerations such as ensuring compliance with data privacy regulations and ethical use of customer data and/or implementing measures to protect customer privacy and secure sensitive information.

This algorithmic approach outlines processing for predicting customer requests across retail and commercial financial products and/or other environments. The success of this approach may depend on the quality of data, the chosen models, and ongoing optimization based on customer feedback and changing market dynamics.

FIG. 3 shows an example demand prediction process 300 according to some embodiments of the disclosure. For example, system 100 may perform process 300 at 202 in process 200 to project and evaluate demand and, in at least some embodiments, establish demand quality. Predicting customer demand can impact an organization's ability to meet its customer needs efficiently and effectively. Accurate demand predictions can enable businesses to optimize resource allocation, enhance customer satisfaction, and stay ahead in a competitive landscape. Organizations can anticipate the surge in demand for products over time. In the following example, these products can include specific financial products, and demand surges may occur during economic shifts. For instance, a bank using predictive analytics might forecast increased demand for mortgage products during periods of low-interest rates, allowing them to proactively manage loan processing capabilities and streamline customer service. However, the disclosed embodiments are not limited to the specific example use cases.

At 302, system 100 can project future customer requests. This part of process 300 can include, for example, collecting customer data and processing the customer data using a first ML model, such as customer demand model 110. System 100 may gather data related to various metrics that may help predict the customer demand for a service (e.g., account opening and servicing). The specific data requirements may vary depending on the type of product and the growth aspirations. The following is an illustrative (not exhaustive and not prescriptive) list that can be collected for predicting customer demand across account opening and servicing demand:

### Demographic Information:

For Individuals: Name, age, gender, marital status, occupation, income, education level, and location.
For Businesses: Business name, industry, size, location, and years in operation.

### Financial History:

Personal or business credit history, if applicable.
Previous banking relationships and account behavior.

### Transaction Data:

Historical transaction data, including frequency, volume, and types of transactions.
Information on account balances and spending patterns.

### Product-Specific Information:

Savings/Checking Accounts: Average balance, transaction frequency, overdraft history.
Credit Cards: Credit limit, usage patterns, outstanding balance.
Loans: Loan type, amount, duration, repayment history.

### Online and Mobile Interactions:

Data on online and mobile banking activities, including logins, app usage, and digital transactions.

### Market and Economic Indicators:

Economic indicators relevant to the market where the institution operates.
Interest rates, inflation rates, and other macroeconomic factors.

### Customer Interactions and Inquiries:

Records of customer inquiries, interactions with customer service, and feedback.

### Marketing and Campaign Data:

marketing campaigns, including channels used, response rates, and conversion rates.

### External Data:

Social media data for sentiment analysis and customer behavior.
Public records for legal and regulatory compliance.

### Seasonal and Temporal Data:

Evaluate the impact of seasonality on demand, as well as temporal factors. Are there specific times of the year or days of the week when demand is higher?

### Regulatory and Compliance Data:

Ensure compliance with relevant regulations by collecting data necessary for regulatory reporting.

### Customer Feedback and Surveys:

Surveys or feedback data to understand customer satisfaction and preferences.

### Customer Segmentation:

Segmentation data to categorize customers based on behavior, preferences, and other relevant criteria.

### Competitor Data:

competitor products, promotions, and market share.

### Fraud and Security Data:

fraud attempts, security incidents, and measures taken to mitigate risks.

### Operational Data:

Internal operational data such as system downtime, processing times, and service availability.

### Customer Lifecycle Data:

Stage of the customer lifecycle, from acquisition to retention.

### Technological Trends:

Emerging technologies impacting financial services, such as blockchain or artificial intelligence.

### Environmental, Social, and Governance (ESG) Factors:

Consideration of ESG factors that might influence customer decisions.

### Legal and Regulatory Changes:

laws and regulations that may impact financial services.

System 100 may prepare raw data such as that described above for ML processing, which may include identifying metrics for processing by the first ML model and preparing the data accordingly. In order to identify metrics and prepare the data, there should be a clearly defined goal of predicting demand (e.g., demand for financial products). An understanding of the distribution of the target variable (demand) and patterns in the data may be valuable. To that end, system 100 may perform one or more of the following data preparation actions:
Identify and address missing values in the dataset through imputation or removal. System 100 may use techniques such as mean imputation or advanced imputation methods based on the nature of the data.
Identify irrelevant or redundant metrics that may not contribute significantly to the prediction. System 100 may use techniques like correlation analysis, recursive feature elimination, or feature importance from tree-based models.
Convert categorical metrics into numerical representations using techniques such as one-hot encoding or label encoding. System 100 may create dummy metrics for categorical features with multiple levels.
Extract temporal variables if the data involves a time dimension such as day of the week, month, quarter, or year. Extraction may be based on a time period defined by events such as time since last transaction or account opening.
Create aggregated metrics to capture trends and patterns such as calculate mean, median, sum, standard deviation, etc., for relevant numerical metrics. Aggregations over different time windows can capture seasonality.
Identify potential interactions between metrics by creating new variables. For example, system 100 may identify the product of two numerical variables or combinations of categorical variables.
Apply mathematical transformations to numerical metrics to improve linearity or distribution: Logarithmic transformation for skewed distributions and square root transformation or Box-Cox transformation, for example.
Standardize or normalize numerical features to ensure they have similar scales. Techniques such as Min-Max scaling or Z-score normalization can be applied.
Introduce features specific to the financial domain such as customer profitability, churn probability, customer lifetime value, economic indicators relevant to financial product demand. System 100 can refer to the data collection examples to build upon domain specific features.
Create features based on customer segmentation such as group customers by behavior, demographics, or transaction patterns and use these groups as features.
For text data related to customer feedback or reviews, perform sentiment analysis (as applicable), and use sentiment scores as features.
Derive insights from external data sources such as economic indicators, market trends, or demographic data.
Ensure that all features are on a similar scale to prevent certain features from dominating the learning process.
Apply techniques such as Principal Component Analysis (PCA) if dealing with a high-dimensional dataset to reduce the number of features.
Encode categorical variables based on the mean of the target variable for each category.
Create cross features by combining two or more features. For example, combining the features “transaction amount” and “transaction frequency.”
Add regularization terms to penalize large coefficients and avoid overfitting if you are using linear models.
Regularly test the impact of newly engineered features on model performance using cross-validation or a separate validation set.
Keep detailed documentation of the metrics created, transformations applied, and their rationale.
Metric engineering is an iterative process. Continuously refine and experiment with new features based on model performance and feedback.

By performing one or more of the above-described processing options, system 100 can systematically engineer metrics that enhance the predictive power of customer demand model 110 when forecasting demand for financial products. System 100 may ensure that the chosen features align with the specific characteristics of the products and the business objectives.

Based on the data being collected and the metrics as developed above, a relevant model may be selected for use as customer demand model 110. Several considerations may be evaluated in configuring customer demand model 110. For example, if system 100 has a large data set to evaluate with a large number of input metrics, a random forest, gradient boosting, and/or neural network model may be appropriate; whereas if the data set and/or metrics counts are small, a decision tree and/or linear regression model may be appropriate. If system 100 is predicting continuous or numerical value (regression), a linear regression, decision tree, random forest, gradient boosting, and/or neural network model may be appropriate; whereas for time series forecasting, an autoregressive integrated moving average, exponential smoothing state space, and/or long short-term memory network model may be appropriate. If system 100 is publishing information about the model's inner workings, a linear regression and/or decision tree model may be appropriate; whereas if the model's structure is kept private, a random forest, gradient boosting, and/or neural network model may be appropriate.

Ultimately, system 100 may use a combination of these methods for various products in various embodiments. For example, system 100 may random forest for account opening demand and gradient boosting for servicing demand. Customer demand model 110 may combine the output of both these models to derive a final prediction. In another example, system 100 may use ARIMA (Auto Regressive Integrated Moving Average) to account for seasonality and LSTM (Long Short-Term Memory) to capture long-term dependencies in sequential data. System 100 may also factor customer behavior across various segment such as retail, commercial etc. and may use random forest to predict account opening demand considering various customer segments and logistic regression within each segment to account for different servicing behaviors among customer groups. Customer demand model 110 may combine the output of each of these models to derive a final prediction.

At 304, system 100 can validate projections against alignment with historical data. To accomplish this, system 100 can process the data gathered at 302 using the selected customer demand model 110. System 100 can validate the output of customer demand model 110 by performing one or more of the following actions:
Split the dataset into training and testing sets. The training set may be used to train the model, while the testing set may be used to assess its performance on new, unseen data.
   Implement k-fold cross-validation on the training set to obtain a more robust estimate of the model's performance.
   Choose appropriate performance metrics based on the nature of the prediction task. For example, Regression: Mean Squared Error (MSE), Root Mean Squared Error (RMSE).
   Train the model on the training set and evaluate its performance on the validation set. Repeat this process for each fold in cross-validation.
   Fine-tune model hyperparameters based on performance during cross-validation. Use techniques like grid search or randomized search.
   Compare the performance of different models or model configurations to identify the most effective one.
   Evaluate model performance on the held-out testing set to assess how well it generalizes to new data.
   Visualize the model's performance using appropriate plots, such as ROC curves, precision-recall curves, or calibration plots.
   Analyze model errors on the testing set to identify patterns or specific cases where the model struggles.
   Examine feature importance or coefficients (for linear models) to understand which variables contribute most to predictions.
   Calibrate the errors, challenges, and outcomes with subject matter experts from the business and ensure alignment at all stages.
   Implement monitoring mechanisms to track the model's performance over time in a live environment. This may include regular assessments of metrics and periodic model retraining. This may also include running the model to predict historical demand and cross-verify if the outcome aligns with the actual demand.
   Keep detailed documentation of the validation process, including the metrics used, model configurations, and any challenges encountered.
   Communicate the validation results and model performance to relevant stakeholders, ensuring transparency and facilitating informed decision-making.
   Consider model refinement based on insights gained during the validation process. This may involve additional feature engineering, adjusting hyperparameters, or exploring different model architectures.

At 306, system 100 can train the first ML model, customer demand model 110. For example, if the evaluation at 304 indicates that customer demand model 110 is out of alignment with the historical data, system 100 may retrain customer demand model 110. In some embodiments, training the first ML model may include performing processing comprising collecting first training data indicative of at least one customer trait (or using the data collected as described above), creating first ML input training data by transforming at least a portion of the first training data (or using data as transformed as described above), dividing the first ML input training data into a training set and a testing set, training the first ML model on the training set, and testing the first ML model by processing the testing set with the first ML model.

At 308, system 100 can review projected customer requests against quality data and grade the quality of the demand. Quality of inputs provided by customers can be a factor for servicing demand effectively. Accurate and comprehensive information from customers can form the foundation for organizations (e.g., financial institutions) to tailor their products and services to meet specific needs. Incorrect inputs such as missing documents, incorrect signature, or incomplete application form can cause rework and delays in timely completion of the customer requests. Further, this rework can create stress on resourcing and increases the servicing costs. Reliable inputs can enhance the overall efficiency of financial processes, leading to improved customer satisfaction and trust.

System 100 can use one or more statistical models to assess and grade the quality of demand in various ways. The choice of a statistical model may depend on the specific characteristics of the data and the goals of the quality assessment. For example, system 100 may use one or more of the following statistical models:
System 100 may apply clustering to customer inputs to group them based on similarities. This can reveal distinct segments of data, making it easier to identify and address specific quality issues within each cluster. For example, cluster analysis can help identify similar groups who have habitually submitted erroneous information. System 100 can use this analysis to grade the segment wise demands. For example, the customer inputs may be distributed among different clusters based on their frequency of occurrence and how they match with the quality grades. Each cluster can indicate a group of customer inputs that have similar patterns in the original features. For example, some clusters can indicate the customer inputs that have high values of incomplete document and incorrect signature, but low values of illegible documents and wrong information. Other clusters can indicate the customer inputs that have low values of all the original features. Other clusters can indicate the customer inputs that have high values of illegible documents and wrong information, but low values of incomplete document and incorrect signature. Other clusters can indicate the customer inputs that have moderate values of all the original features. Other clusters can indicate the customer inputs that have high values of all the original features. In one example presented to explain the clustering concepts, inputs with grade A may have the highest frequency in the cluster with customer inputs that have high values of incomplete document and incorrect signature, but low values of illegible documents and wrong information, meaning they are most common in that cluster. On the other hand, the inputs with grade F may have the lowest frequency customer inputs that have moderate values of all the original features, which means they are the least common in that cluster. Inputs with grade B and C may have more balanced frequencies among different clusters, which means they are more evenly distributed in the data. By performing such an analysis, system 100 can segment and classify customer inputs based on their original features and improve process quality and efficiency.
System 100 can train one or more decision trees to evaluate customer inputs and classify them based on their quality. The tree structure may provide a transparent way of understanding which features contribute most to the quality assessment, thereby illustrating how the quality of customer inputs affects the outcome of a process or a service. For example, if the input documents are incomplete or illegible, the grade may be likely to be F, which means the customer is not satisfied or the process is not successful. On the other hand, if the input documents are correct and clear, the grade may be likely to be A or B, which means the customer is happy or the process is efficient. Decision trees can determine which features are more important for determining the grade, such as the incorrect signature feature in this example. The decision tree can help system 100 to develop a grading system to ensure that the demand is properly evaluated.
System 100 can apply principal component analysis (PCA) to customer input data to identify the dimensions (features) that capture the variability in the data. This can help focus on the key factors influencing the quality of inputs. PCA can illustrate how the customer inputs are related to each other and how they vary across different quality grades. For example, inputs with grade A may tend to have higher values of incomplete document, which means they have more variation in the original features. On the other hand, the inputs with grade F may tend to have lower values of incomplete document, which means they have less variation in the original features. Inputs with grade B and C may be more clustered together, which means they have similar patterns in the original features. PCA can help system 100 reduce the dimensionality of the data and visualize the main sources of variation and correlation among the customer inputs.
System 100 can apply anomaly detection models to customer inputs to flag unusual or outlier data points that may indicate errors or inaccuracies, which may indicate inputs that are outliers or abnormal compared to the rest of the data. For example, inputs with grade F may have the lowest median anomaly score, which means they have the most anomalies. These inputs may have some errors or issues that make them different from the normal inputs. On the other hand, the inputs with grade A may have the highest median anomaly score, which means they have the least anomalies. These inputs may have high quality and efficiency. Inputs with grade B and C may have more variation in their anomaly scores, which means they have more diversity in the original features. This analysis can help system 100 detect and handle the anomalous customer inputs and improve process quality and efficiency.

ML model effectiveness may depend on the nature of the data describing the quality of inputs. Depending on number of factors influencing the demand and product features, system 100 may use a combination of these models, or an ensemble approach may be used to provide a more comprehensive input to grade the customer demand.

At 310, system 100 can adjust the demand. For example, if processing at 308 indicates that the input quality is poor, system 100 can request additional input data and repeat process 300 with new data when it is received.

Following the demand prediction, system 100 can perform processing to determine a service's ability to meet the predicted demand (e.g., see 202-210 of process 200 described above). Specific details about processing that can determine the service's ability to meet the predicted demand is given in detail below. Before implementing such details, it may be informative to consider factors that can influence service capabilities that may be relevant to one or more aspects of the processing. The following are some examples of factors that may be used by system 100 in subsequent processing:
Customer feedback and satisfaction may serve as indicators of service quality. Customers feel the impact of a good or bad service from an organization. Analyzing reviews and satisfaction scores may provide insights into the customer experience, helping businesses understand what works well and areas that require improvement. Continuous monitoring of feedback trends may facilitate responsive adjustments to meet evolving customer expectations.
Service Level Agreements (SLAs): SLAs may set expectations for response and resolution times. Adherence to SLAs may contribute to delivering prompt and efficient service. SLAs are generally defined from a customer's perspective. For example, meeting the agreed timelines for a product or service or delivering the product/service with a pre-agreed quality standard. Assessing the effectiveness of SLAs may ensure that customer expectations align with the business's capabilities, contributing to positive customer experiences and loyalty. SLA metrics may include, but are not limited to, resolution time adherence, first time resolution, cases reopened, complaints, and/or adherence to procedures.
Resource capability, training, and engagement may be considered. Resources can be defined as elements that contribute to efforts to achieve the SLAs. SLAs may be achieved using employees, robots, vendor services, or machines, for example. The competency and engagement of human resources may impact service quality. Investing in comprehensive training programs may ensure staff proficiency, while maintaining high employee engagement levels may foster a positive work environment, translating into improved customer interactions. For the non-human resources, periodic checks and maintenance may be conducted to ensure highest levels of availability. Services provided by vendors may follow similar engagement and conversations as human resources. Resource capability, training, and engagement metrics may include, but are not limited to, refresher training attendance/coverage, training effectiveness, quality audit scores, capability test scores, production availability, productivity, failure mode analysis, engagement scores, and/or vendor contract review.
Process design and technology may also be evaluated. The efficiency of the process and platforms may directly influence the effectiveness of support. If the process is designed to include numerous inspections, validations, etc., the chances of failure may increase. Businesses may regularly evaluate and invest in advanced technologies to streamline processes, reduce bottlenecks, and mechanize the process. Integration of cutting-edge tools may ensure a seamless and modern customer service experience. Embracing innovation in customer service may contribute to staying competitive. Regularly assessing processes and incorporating customer feedback may drive continuous improvement. Process design and technology metrics may include, but are not limited to, input quality, median handling time, median wait time, process capability index (Cp), process capability index for centering (Cpk), defects per million opportunities (DPMO), process performance index (Pp), and/or Z score.
Communication channels may be useful for meeting diverse customer preferences. Recent trends indicate an electronic channel generates much better service capability in comparison with paper-based process. Evaluating the availability and effectiveness of channels such as phone, email, chat, and social media may help businesses optimize their multi-channel strategy. Consistency in messaging across platforms may ensure a unified customer experience. Communication channel metrics may include, but are not limited to, first contact resolution (FCR), input quality, SLA adherence, channel response time, customer effort score (CES), abandoned requests, conversion rate, channel preferences, and/or cross-channel consistency.
Customer service metrics may include key performance indicators (KPIs) that may be useful for measuring and improving service quality. Tracking metrics like response time, rework, resolution time, and customer retention rates can provide valuable insights into operational efficiency. Regular analysis of KPIs may enable businesses to identify areas for enhancement and celebrate successes. Acknowledging cultural nuances and demographic factors can be useful for tailoring service capability. Customer service metrics may include, but are not limited to, FCR, customer satisfaction (CSAT), net promoter score (NPS), CES, abandoned requests, repeat contact rate, escalation rate, customer retention rate, churn rate (e.g., percentage of customers who stop using service), quality of service (QOS), knowledge base use measurement (e.g., how frequently customers access self-service resources), cross-sell and/or up-sell opportunities, social media engagement, and/or accessibility and inclusivity.
Resource allocation, including staff and budget, may be valuable for meeting customer service demands when done efficiently. Further, this allocation may be dynamic and not hard coded to ensure flexibility. Striking the right balance with effective collaboration may ensure that the business can respond effectively to customer needs without overextending or compromising service quality. Optimal resource allocation may be useful for sustainable and scalable customer service operations. Resource allocation metrics may include, but are not limited to, resource utilization rate, capacity planning accuracy, workforce productivity, resource availability, and/or skill set match. Resource balancing metrics may include, but are not limited to, workload distribution, task prioritization, queue length, resource redundancy, and/or time to resolution. Resource fungibility management metrics may include, but are not limited to, resource flexibility, cross-training effectiveness, resource rotation, resource scalability, and/or resource allocation cost.

These are some example factors that may have broad applicability to a variety of systems. In at least some embodiments, additional factors such as adaptability, competition analysis, and crisis management may also be useful. Regulatory compliance and customer data privacy may provide further “guard rails” whilst building and sustaining this model. Examples of other metrics may include, but are not limited to, customer service scalability, benchmarking against competitors, downtime during crises, compliance audit results, localization effectiveness, rate of new technology adoption, and/or data breach incidents.

FIG. 4 shows an example resource availability projection process 400 according to some embodiments of the disclosure. For example, system 100 may perform process 400 at 204 in process 200. One of the challenges of managing a service is to ensure that the resources available are sufficient to meet the demand from customers. However, demand is not constant and may vary depending on various factors, such as seasonality, marketing campaigns, customer preferences, and external events. Further, quality of inputs may also vary across various products and geographies. Therefore, system 100 may predict the demand for different customer segments and, as described in detail with respect to later figures, adjust the resource allocation accordingly. This is the goal of predicting resource availability to meet predicted graded customer demand. In the following example, system 100 may be configured to predict resource availability and demand based on historical data and statistical methods.

At 402, system 100 may integrate resource plans with historical resource availability and/or grade internal and/or external factors that may influence resource availability. This can include sourcing relevant data and/or grading factors within the data. Data may include internal data 20 and/or external data 30. Relevant factors within internal data 20 may include, but are not limited to, the following examples:

### Workforce Capacity and Capability:

Workforce Capacity: Number of full-time equivalents (FTEs), staffing levels.
Workforce Productivity: Output per employee, revenue per employee.
Skill Set Match: Percentage of employees with required skills, skills Index.

### Resource Utilization:

Data on inventory levels, stock movements, and turnover rates. This data may illustrate how resources are utilized over time.
Production and Operations Metrics: Production output, availability, approved downtime, manufacturing efficiency, and operational performance. This may include metrics such as throughput, cycle times, and machine utilization.
Employee Productivity Metrics: Workforce productivity, availability and wait and down time metrics to understand how human resources contribute to overall resource utilization.

### Quality:

Inspections, tests, and audits from quality control processes. Quality issues and Operational Loss documentation and the corresponding resolutions.
Supplier Quality Metrics such as defect rates, compliance with specifications, and on-time delivery performance.
Customer Feedback on Quality such as surveys, reviews, or direct communication such as complaints.

### Attrition or Downtime Data:

Documented instances of equipment maintenance, repairs, and downtime. This may include details on the duration of downtime, reasons for maintenance/breakdown, and actions taken to resolve issues.
Employee turnover rates, reasons, and tenure of the resources.
Reasons, duration, actions about incidents or disruptions that affected operations such as power outages, natural disasters, or other external factors contributing to downtime.

### Technology and Infrastructure:

System Uptime: Percentage of time systems are operational.
Processing Speed: Time taken to process customer requests.
Technology Downtime: Time systems are unavailable due to maintenance or issues.

### Operations:

Cycle Time: Time taken to complete a process or task.
Error Rate: Percentage of errors in processes.
Process Efficiency: Resources utilized per unit of output.

### Organizational Culture:

Employee satisfaction, engagement, retention, and turnover rates.
   Risk tolerance:
Risk metrics, such as probability, impact, and exposure of risks.

Relevant factors within external data 30 may include, but are not limited to, the following examples:

### Market Conditions:

Market Share: Percentage of total market captured, penetration, and segmentation.
Demand Forecast Accuracy: Accuracy of predictions for future demand.
Customer Acquisition Rate: Rate of acquiring new customers.

### Economic Conditions:

Gross Domestic Product (GDP) Growth: Economic performance.
Inflation Rate: Impact on costs and pricing.
Consumer Spending: Influences demand for products or services.

### Competitor Activities:

Market Share of Competitors: Understanding competitive positioning.
Pricing Analysis: Comparison of prices with competitors.
Product or Service Differentiation: Measuring uniqueness.

### Regulatory Environment:

Compliance Rate: Adherence to regulatory requirements.
Audit Results: Outcome of regulatory audits.
Legal Disputes: Number of legal issues and their impact.

### Digitization:

Speed of adopting new technologies to digitize processes.
Time taken to integrate new technologies and migrate business processes.

### Consumer Trends:

Consumer metrics, such as customer loyalty, retention, and lifetime value.

### Social and Cultural Factors:

Customer Satisfaction Score (CSAT): Measure of customer satisfaction.
Brand Perception: How the brand is perceived in society.
Customer Feedback Analysis: Qualitative analysis of customer feedback.

Resource availability to service customer demand is may be influenced by a multitude of internal and external factors within an organization, such as those examples given above and/or other examples. Measurable metrics for each factor can help in assessing and managing these influences effectively. Grading factors based on their correlation with prediction of resource availability may contribute to enhancing the predictive power of a model for one or more of the following reasons:
Helps identify which factors have a substantial impact on predicting resource availability. By assigning grades, system 100 can prioritize and focus on the most influential features in the predictive model.
   Aids in feature selection, guiding the process of choosing the most relevant features for the predictive model. Features with high grades may be likely to contribute significantly to the prediction, while those with lower grades may have less impact.
   Focusing on the most impactful features can improve the performance of the predictive model.
   Grades can provide a straightforward and interpretable way to communicate the importance of each factor to stakeholders.
   Facilitates identifying factors that may pose risks or challenges to resource availability.
   Provides a basis for strategic decision-making.
   Contribute to building trust in predictive models.

To grade factors in terms of their support in predicting resource availability, system 100 can perform one or more of the following functions:
1. Calculate the correlation coefficients between each individual factor and Resource Availability.
   2. Examine both the sign (positive or negative) and the magnitude of each correlation coefficient. A positive correlation can indicate a positive relationship, while a negative correlation can indicate a negative relationship. The magnitude can represent the strength of the relationship.
   3. Define thresholds for different grades based on the magnitude of correlation coefficients. For example: Grade ‘A’: Strong correlation (e.g., 0.8 to 1.0 or −1.0 to −0.8), Grade ‘B’: Moderate correlation (e.g., 0.6 to 0.8 or −0.8 to −0.6), Grade ‘C’: Weak correlation (e.g., 0.4 to 0.6 or −0.6 to −0.4), and/or Grade ‘D’: Little to no correlation (e.g., 0.0 to 0.4 or −0.4 to 0.0).
   4. Consider the sign of the correlation coefficient. If positive, the sign can suggest a positive impact on resource availability. If negative, the sign can suggest a negative impact. This may be reflected in the grading system.
   5. Summarize the grades for each factor and visualize the results. This could be done through a table or a bar chart, showing the grades assigned to each factor, for example.
   6. Consider domain knowledge, business context and subject matter expertise to adjust the grades. Some factors may have a strong theoretical connection to resource availability even if the correlation is moderate.

At 404, system 100 may run the second ML model (e.g., resource availability model 120) to project resource availability. Once the grading is complete, system 100 can apply a second ML model, such as resource availability model 120, to predict the resource availability. The choice of a statistical model can align with the characteristics of the data and the complexity of the relationship between resource availability and demand for each product. Additionally, model performance can be validated using appropriate metrics and fine-tuned based on the specific requirements of the business. The following are model examples with illustrations indicating how each model may predict resource availability, and these or other models may be used alone or in combination as the second ML model to project resource availability:
Time Series Models (ARIMA, Exponential Smoothing) may be well-suited for forecasting demand patterns over time. This could be useful for understanding seasonal fluctuations and trends in demand for services such as financial products.
   Decision Trees may be useful for capturing nonlinear relationships and interactions between different factors influencing resource availability.
   Random Forest, being an ensemble of decision trees, can provide improved accuracy and robustness, making it suitable for complex prediction tasks.
   Support Vector Machines (SVM) can be applied when there is a need to capture complex relationships between resource availability and demand with a high-dimensional feature space.
   Neural Networks, with their capacity to capture intricate patterns, can be beneficial for understanding complex relationships in financial product demand.
   Bayesian Models could incorporate prior knowledge or beliefs about the factors influencing resource availability for each financial product.
   Regression with Lasso or Ridge Regularization can help prevent overfitting and select relevant features for predicting resource availability.
   Gradient Boosting Models (e.g., XGBoost, LightGBM) can be powerful for combining the strengths of multiple weak learners and improving predictive accuracy.

At 406, system 100 may determine whether the output of the second ML model indicates any anomalous trends. Once the model is run, system 100 may fine tune the predictions. This activity may include aligning the grades, reviewing outlier trends, etc. For example, system 100 can predict historical resource availability using the model and then compare how the actual data came in during a given time period. This method can help validate the model if the factors are calibrated. If there is a lack of alignment between model projections and real data, processing may proceed to 408.

At 408, system 100 can train the second ML model to correct anomalous performance as determined at 406. In some embodiments, training the second ML model may include performing processing comprising collecting first training data indicative of at least one resource availability trait (or using the data collected as described above), creating second ML input training data by transforming at least a portion of the second training data as necessary, dividing the second ML input training data into a training set and a testing set, training the second ML model on the training set, and testing the second ML model by processing the testing set with the second ML model. After retraining, system 100 can perform processing at 404 to run the retrained model and processing at 406 to check the retrained model.

At 410, system 100 can project resource availability and/or determine available production time. For example, if no anomalous trends are identified at 406 and/or if such anomalous trends are corrected by retraining at 408 followed by re-running the model, system 100 can report the output of second ML model processing, and/or such output may be used for subsequent processing by system 100 as described in detail below.

FIG. 5 shows an example resource capability projection process 500 according to some embodiments of the disclosure. For example, system 100 may perform process 500 at 206 in process 200. Resource capability may play a role in meeting customer demand promptly and ensuring quality outcomes. These resources may refer to human capital, but can also refer to technology, financial assets, equipment, and materials. An organization's ability to efficiently measure, tune, and maintain optimal standards of resources may directly impact production timelines and service delivery. Adequate and capable resources, both human and material, can enable streamlined processes, reducing delays and enhancing responsiveness. Moreover, resource proficiency can enhance the quality of products or services, contributing to customer satisfaction. A well-managed resource capability function may not only optimize operational efficiency but may also establish a reputation for reliability, fostering customer loyalty and sustaining long-term business success.

At 502, system 100 may align resource capability with historical resource capability and/or grade internal and/or external factors that may influence resource capability. This can include sourcing relevant data and/or grading factors within the data. Data may include internal data 20 and/or external data 30. Relevant factors within internal data 20 may include, but are not limited to, the following examples:
1. Employee capabilities can encompass the collective skills, knowledge, competencies, and attributes that individuals bring to an organization. These capabilities may be useful for determining an employee's effectiveness in their role and their contribution to the overall success of the organization. The following are several example factors which may determine employee capabilities:
   Mastery of job-specific skills, tools, and technologies required for efficient task execution.
   Interpersonal skills, communication, teamwork, adaptability, and emotional intelligence.
   The capacity to analyze issues, generate solutions, and make informed decisions.
   The ability to objectively analyze information, assess situations, and make reasoned judgments.
   Inherent qualities or developed skills that indicate the ability to lead and influence others.
   Willingness and ability to quickly learn and apply new information or skills.
   Ability to think creatively, generate new ideas, and contribute to innovative solutions.
   Capacity to adjust to changes in the work environment and embrace new methodologies.
   Effectively conveying information, ideas, and instructions through various channels.
   Prioritize tasks, set goals, and efficiently manage time and workload.
   Consistently making decisions aligned with ethical principles and organizational values.
   Prioritizing and meeting customer needs, both internal and external.
   Ensuring organization's interest is safeguarded and beneficial from every activity undertaken by the employee.
2. Efficient systems may enhance productivity and contribute to overall resource capability by avoiding rework.
3. Cultural alignment may influence how resources are managed and utilized.
4. Competent leadership may foster strategic resource allocation and optimization.
5. Streamlined processes may minimize resource waste and enhance overall effectiveness.

For example, in at least some embodiments, system 100 may obtain data related to the following metrics for the above-referenced internal factors:

### Employee Capabilities:

Skill Proficiency: Skills matrix evaluations, certification attainment, and training completion rates.
Productivity Index: Sales/count of completed production per unit of time or resources.
Innovation Contribution: Number of implemented suggestions, patents, or successful innovation projects.
Problem-Solving Effectiveness: Time taken to solve problems, feedback on solutions, and successful issue resolution.
Adaptability and Learning Agility: Training program participation, time to proficiency in new tasks, and cross-functional training success.
Collaboration Skills: Team project success, peer feedback, and collaboration in cross-functional initiatives.
Leadership Potential: Participation in leadership development programs, successful project leadership, and 360-degree feedback.
Communication Effectiveness: Feedback on communication skills, successful team communication, and clarity in conveying instructions.
Time Management: Project completion within deadlines, time-tracking metrics, and task prioritization success.
Customer Satisfaction Impact: Customer feedback related to employee interactions, customer retention, and Net Promoter Score (NPS).
Training Return on Investment (ROI): Comparing performance improvements or project success rates before and after training.
Cross-Functional Collaboration: Participation in cross-functional teams, successful completion of cross-functional projects, and feedback from other departments.
Mentorship Impact: Success of mentees, career progression of those mentored, and feedback from mentees.
Attendance and Punctuality: Absenteeism rates, tardiness frequency, and adherence to work schedules.
Professional Development Engagement: Participation in professional development activities, pursuit of further education, and engagement with mentorship programs.

### Technology Infrastructure:

System Uptime Percentage: Measure of the time technology systems are operational.
Integration Efficiency: Evaluation of how well different systems work together.
Software Utilization Rates: Tracking the extent to which software tools are used.

### Organizational Culture:

Employee Satisfaction Index: Regular surveys measuring employee contentment.
Cultural Alignment Assessments: Evaluation of alignment between individual values and organizational culture.
Employee Turnover Rates: An indicator of how well the culture retains talent.

### Leadership Effectiveness:

Measurement of the level of commitment and enthusiasm among employees.
The impact of leadership training initiatives.
360-Degree Feedback: Gathering insights from peers, subordinates, and superiors on leadership effectiveness.

### Process Efficiency:

Process Cycle Time: Duration from the initiation to the completion of a process.
Error Rates: Frequency of errors or defects in the output of a process.
Efficiency Benchmarks: Comparison of process efficiency against industry standards.

Relevant factors within external data 30 may include, but are not limited to, the following examples:
1. External demand and competition may shape resource utilization strategies.
2. Compliance requirements may impact resource allocation and operational strategies.
3. Economic conditions may influence resource availability and financial allocations.
4. Dependence on external suppliers may affect the reliability of resource inputs.
5. Advances in digitization efforts can alter resource requirements and capabilities.

For example, in at least some embodiments, system 100 may obtain data related to the following metrics for the above-referenced external factors:

### Market Dynamics:

The percentage of total market sales an organization captures.
   Precision in predicting customer demand for products or services.
   Evaluation of the organization's position relative to competitors.

### Regulatory Environment:

Outcomes of audits assessing adherence to regulatory requirements.
Frequency and severity of non-compliance instances.
Evaluations of how well the organization adheres to regulatory guidelines.

### Economic Trends:

Growth rate in the country's Gross Domestic Product.
The percentage increase in the general price level of goods and services.
Metrics relevant to the specific industry in which the organization operates.

### Supplier Relationships:

Assessments of supplier reliability, quality, and timeliness.
The time taken for suppliers to deliver resources.
Evaluations of the quality of resources received from suppliers.

### Digitization Efforts:

How quickly and extensively the organization adopts new technologies.
Allocation of resources to innovate and develop new technologies.
Measurement of the success of implemented technological innovations.

System 100 may grade the factors. Grading factors based on their correlation with prediction of resource capability may be beneficial for several reasons that may contribute to enhancing the predictive power of a model, such as the following example reasons:
Helps identify which factors have a substantial impact. By assigning grades, system 100 can prioritize and focus on the most influential features in the predictive model.
   Aids in feature selection, guiding the process of choosing the most relevant features for the predictive model. Features with high grades may be likely to contribute significantly to the prediction, while those with lower grades may have less impact.
   Focusing on the most impactful features can improve the performance of the predictive model.
   Provides a straightforward and interpretable way for system 100 to communicate the importance of each factor to stakeholders.
   Facilitates identifying factors that may pose risks or challenges to resource availability.
   Provides a basis for strategic decision-making.
   Contributes to building trust in predictive models.

To grade factors in terms of their support in predicting resource capability, system 100 can perform one or more of the following functions:
1. Calculate the correlation coefficients between each individual factor and resource capability.
2. Examine both the sign (positive or negative) and the magnitude of each correlation coefficient. A positive correlation may indicate a positive relationship, while a negative correlation may indicate a negative relationship. The magnitude may represent the strength of the relationship.
3. Define thresholds for different grades based on the magnitude of correlation coefficients. For example: Grade ‘A’ may indicate a strong correlation (e.g., 0.8 to 1.0 or −1.0 to −0.8), Grade ‘B’ may indicate a moderate correlation (e.g., 0.6 to 0.8 or −0.8 to −0.6), Grade ‘C’ may indicate a weak correlation (e.g., 0.4 to 0.6 or −0.6 to −0.4), and/or Grade ‘D’ may indicate little to no correlation (e.g., 0.0 to 0.4 or −0.4 to 0.0).
4. Consider the sign of the correlation coefficient. If positive, the coefficient may suggest a positive impact on resource availability. If negative, the coefficient may suggest a negative impact. This may be reflected in the grading system.
5. Summarize the grades for each factor and visualize the results. This could be done through a table or a bar chart, showing the grades assigned to each factor, for example.
6. Consider domain knowledge, business context and subject matter expertise to adjust the grades. Some factors may have a strong theoretical connection to resource availability even if the correlation is moderate.

At 504, system 100 may run the third ML model (e.g., resource capability model 130) to project resource capability. Once the grading is complete, system 100 can apply a third ML model, such as resource capability model 130, to predict the resource capability. The choice of a statistical model can align with the characteristics of the data and the complexity of the relationship between resource capability and demand for each product. Additionally, model performance can be validated using appropriate metrics and fine-tuned based on the specific requirements of the business. The following are model examples with illustrations indicating how each model may predict resource capability, and these or other models may be used alone or in combination as the third ML model to project resource capability:
Multiple Regression may be used to analyze the relationship between resource capability and multiple metrics simultaneously, considering potential interactions among variables.
   Principal Component Analysis (PCA) may be used to identify the principal components that capture most of the variability in the metrics. System 100 may construct the Resource Capability Index based on the weights of these principal components.
   Factor Analysis may be used to identify latent factors and use these factors to construct a composite Resource Capability Index.
   Analytic Hierarchy Process (AHP) may be used to establish the importance weights for each metric and create a weighted combination to form the Resource Capability Index.

At 506, system 100 may determine whether the output of the third ML model indicates any anomalous trends. Once the model is run, system 100 may fine tune the predictions. This activity may include aligning the grades, reviewing outlier trends, etc. For example, system 100 can predict historical resource capability using the model and then compare how the actual data came in during a given time period. This method can help validate the model if the factors are calibrated. If there is a lack of alignment between model projections and real data, processing may proceed to 508.

At 508, system 100 can train the third ML model to correct anomalous performance as determined at 506. In some embodiments, training the third ML model may include performing processing comprising collecting first training data indicative of at least one resource capability trait (or using the data collected as described above), creating third ML input training data by transforming at least a portion of the second training data as necessary, dividing the third ML input training data into a training set and a testing set, training the third ML model on the training set, and testing the third ML model by processing the testing set with the second ML model. After retraining, system 100 can perform processing at 504 to run the retrained model and processing at 506 to check the retrained model.

At 510, system 100 can project resource capability. For example, if no anomalous trends are identified at 506 and/or if such anomalous trends are corrected by retraining at 508 followed by re-running the model, system 100 can report the output of third ML model processing, and/or such output may be used for subsequent processing by system 100 as described in detail below.

FIG. 6 shows an example process capability projection process 600 according to some embodiments of the disclosure. For example, system 100 may perform process 600 at 208 in process 200. Process capability may contribute to meeting customer demand by ensuring consistent and predictable outcomes in manufacturing or service delivery. Process capability may quantify a process's ability to produce products or services within specified tolerances. High process capability may indicate fewer defects and variations, leading to increased product quality and customer satisfaction. Meeting customer demand may rely on the ability to deliver products or services that meet expectations consistently. By understanding and improving process capability, organizations can optimize efficiency, reduce waste, and enhance reliability, ultimately aligning their operations with customer requirements and maintaining a competitive edge in the market.

At 602, system 100 may align process capability with historical process capability and/or grade internal and/or external factors that may influence process capability. This can include sourcing relevant data and/or grading factors within the data. Data may include internal data 20 and/or external data 30. Relevant factors, and metrics thereof, within internal data 20 may include, but are not limited to, the following examples:

### The Quality of Raw Materials, Equipment, Tools, and Human Resources:

Equipment availability, reliability, and output.
Tool effectiveness.
Employee error rates.
Raw material defect rates.

### Technology Infrastructure:

System Uptime Percentage: Measure of the time technology systems are operational.
Integration Efficiency: Evaluation of how well different systems work together.
Software Utilization Rates: Tracking the extent to which software tools are used.

### Understanding Customer Needs and Expectations:

Customer satisfaction scores.
Defect rates.
On-time delivery.

### Waste and Inefficiency:

Lead time reduction.
Cycle time.
Process flow efficiency.
Error Rates: Frequency of errors or defects in the output of a process.
Efficiency Benchmarks: Comparison of process efficiency against industry standards.

### Smooth and Continuous Workflow:

Work-in-progress (WIP) count and time.
Hold over count and time.
Cycle time.
Throughput % actual vs target.

### Adherence to Demand:

Variation %: Actual vs Demand.
Benched resource.
Idle Time, Overtime.
Inventory turnover.
Lead time.
Order fulfillment time, Turn Around time.

### Standardizing Work Processes:

Standard work adherence.
Process deviation rates.

Relevant factors, and metrics thereof, within external data 30 may include, but are not limited to, the following examples:

### Market Dynamics:

The percentage of total market sales an organization captures.
Precision in predicting customer demand for products or services.
Evaluation of the organization's position relative to competitors.

### Regulatory Environment:

Outcomes of audits assessing adherence to regulatory requirements.
Frequency and severity of non-compliance instances.
Evaluations of how well the organization adheres to regulatory guidelines.

### Economic Trends:

Growth rate in the country's Gross Domestic Product.
The percentage increase in the general price level of goods and services.
Metrics relevant to the specific industry in which the organization operates.

### Supplier Relationships:

Assessments of supplier reliability, quality, and timeliness.
The time taken for suppliers to deliver resources.
Evaluations of the quality of resources received from suppliers.

### Digitization Efforts:

How quickly and extensively the organization adopts new technologies.
Allocation of resources to innovate and develop new technologies.
Measurement of the success of implemented technological innovations.

System 100 may grade the factors. As discussed above with respect to resource capability, grading factors based on their correlation with prediction of resource availability may be beneficial for several reasons that may contribute to enhancing the predictive power of a model. To grade factors in terms of their support in predicting resource availability, system 100 can perform one or more of the following functions:
1. Calculate the correlation coefficients between each individual factor and resource capability.
2. Examine both the sign (positive or negative) and the magnitude of each correlation coefficient. A positive correlation may indicate a positive relationship, while a negative correlation may indicate a negative relationship. The magnitude may represent the strength of the relationship.
3. Define thresholds for different grades based on the magnitude of correlation coefficients. For example: Grade ‘A’ may indicate a strong correlation (e.g., 0.8 to 1.0 or −1.0 to −0.8), Grade ‘B’ may indicate a moderate correlation (e.g., 0.6 to 0.8 or −0.8 to −0.6), Grade ‘C’ may indicate a weak correlation (e.g., 0.4 to 0.6 or −0.6 to −0.4), and/or Grade ‘D’ may indicate little to no correlation (e.g., 0.0 to 0.4 or −0.4 to 0.0).
4. Consider the sign of the correlation coefficient. If positive, the coefficient may suggest a positive impact on resource availability. If negative, the coefficient may suggest a negative impact. This may be reflected in the grading system.
5. Summarize the grades for each factor and visualize the results. This could be done through a table or a bar chart, showing the grades assigned to each factor, for example.
6. Consider domain knowledge, business context and subject matter expertise to adjust the grades. Some factors may have a strong theoretical connection to resource availability even if the correlation is moderate.

For example, a positive correlation between “Customer Satisfaction” and “On-Time Delivery” may suggest that improved delivery punctuality tends to enhance customer satisfaction. On the other hand, a negative correlation between “Defect Rates” and “Employee Satisfaction” may indicate that higher employee satisfaction might contribute to lower defect rates. System 100 can convert the correlation scores to grades and integrate the grades into the fourth ML model to predict process capability.

At 604, system 100 may run the fourth ML model (e.g., process capability model 140) to project process capability. Once the grading is complete, system 100 can apply a fourth ML model, such as process capability model 140, to predict the process capability. The choice of a statistical model can align with the characteristics of the data and the complexity of the relationship between process capability and demand for each product. Additionally, model performance can be validated using appropriate metrics and fine-tuned based on the specific requirements of the business. The following are model examples with illustrations indicating how each model may predict process capability, and these or other models may be used alone or in combination as the fourth ML model to project process capability:
Neural Networks: Predicts process capability in scenarios with intricate and non-linear dependencies. This method may require extensive data and careful tuning.
   Random Forests: predicts process capability by aggregating results from multiple decision trees.
   Multiple Regression: extends linear regression to multiple predictor variables, accommodating more complex relationships. This method may require careful consideration of multicollinearity among predictor variables.
   ARIMA (Auto Regressive Integrated Moving Average): May be useful for stationary time series data with identifiable trends and seasonality.
   Exponential Smoothing Models: may be useful in cases where data has changing patterns and varying levels of noise.
   Gaussian Process Regression: may be useful when the prediction involves uncertainty.
   Bayesian Models: predicts process capability by combining historical data with collaboration with subject matter experts.

At 606, system 100 may determine whether the output of the fourth ML model indicates any anomalous trends. Once the model is run, system 100 may fine tune the predictions. This activity may include aligning the grades, reviewing outlier trends, etc. For example, system 100 can predict historical process capability using the model and then compare how the actual data came in during a given time period. This method can help validate the model if the factors are calibrated. If there is a lack of alignment between model projections and real data, processing may proceed to 608.

At 608, system 100 can train the fourth ML model to correct anomalous performance as determined at 606. In some embodiments, training the fourth ML model may include performing processing comprising collecting fourth training data indicative of at least one process capability trait (or using the data collected as described above), creating fourth ML input training data by transforming at least a portion of the fourth training data as necessary, dividing the fourth ML input training data into a training set and a testing set, training the fourth ML model on the training set, and testing the fourth ML model by processing the testing set with the fourth ML model. After retraining, system 100 can perform processing at 604 to run the retrained model and processing at 606 to check the retrained model.

At 610, system 100 may finalize its process capability forecast. For example, if no anomalous trends are identified at 606 and/or if such anomalous trends are corrected by retraining at 608 followed by re-running the model, system 100 can report the output of fourth ML model processing, and/or such output may be used for subsequent processing by system 100 as described in detail below.

FIG. 7 shows an example integration and prediction process 700 according to some embodiments of the disclosure. For example, system 100 may perform process 700 at 210 in process 200 to consolidate all factors determined through processing by the first, second, third, and fourth ML models and determine process capability to meet projected demand. Process 700 may integrate the results of the above-described processing to determine risk predictions that can thereafter be mitigated. For example, the following insights and considerations can feed into process 700.

Customers seek the best on-demand service at a competitive price in this fast-paced, dynamic, and ever connected world. Meeting such demands directly influence the well-being of an industry, such as the financial industry. Hence, predicting the capability to service customers can play a pivotal role in ensuring operational efficiency, customer satisfaction, and overall business success. The ability to anticipate, innovate, and meet customer needs in a timely manner is not only crucial for financial institutions but also extends its relevance to various other industries.

Anticipating customer demand is critical for effective business planning, setting the stage for resource optimization and process efficiency. By accurately predicting what customers are likely to seek, companies can fine-tune inventory levels, preventing stockouts and minimizing excess inventory costs. This foresight can help maintain customer satisfaction and fostering loyalty. Simultaneously, an acute awareness of resource availability can encompass raw materials, skilled manpower, and other critical inputs essential for production. Predictive capability in this domain can empower businesses to meet demand seamlessly, sidestepping shortages and obviating delays.

Coupled with resource availability, an understanding of resource capability can be valuable. This may entail gauging the efficiency and capacity of resources. Predicting this factor may enable the identification of potential bottlenecks, facilitating process optimization for maximum output. This factor can aid in streamlining operations, ensuring that resources are deployed effectively to meet the anticipated customer demand.

Ultimately, the evaluation of process capability can enable scrutiny of the efficacy of internal processes in delivering products or services. Accurate predictions in this sphere can empower businesses to pinpoint areas for improvement, thereby enhancing operational efficiency. A finely tuned process capability may ensure that internal workflows align seamlessly with the predicted customer demand.

In essence, the seamless integration of predicting customer demand, resource availability, resource capability, and process capability can power a business's overarching capability to meet customer demand effectively. This holistic approach can foster proactive planning, efficient resource allocation, and streamlined processes, ultimately fortifying a company's ability to satisfy customer needs in a timely and cost-effective manner. System 100 can perform process 700 to bring all the domains together to seamless predict the business capability.

At 702, system 100 may integrate the outputs of the first, second, third, and fourth ML models. For example, system 100 may have previously obtained the outputs of the first, second, third, and fourth ML models as described above with respect to FIGS. 3-6. In at least some embodiments, in order to integrate these outputs, system 100 may be provisioned to do one or more of the following:
1. Establish a centralized data repository that consolidates information on predicted customer demand, resource availability, resource capability, and process capability. This unified architecture can facilitate real-time access and ensure data consistency.
2. Develop forecasting models to incorporate variables from each other. For example, features used to predict customer demand can support the resource availability prediction model, as described above. Similarly features predicting resource capability and process capability can benefit from each other. This can ensure that predictions are based on a comprehensive understanding of the organization's capabilities and constraints as well as consistent data sets are reused.
3. Implement scenario analysis tools that dynamically simulate different scenarios, considering variations in customer demand, resource availability, and process capability. This dynamic approach may enable the identification of potential gaps under varying conditions.
4. Utilize automated data processing tools to streamline the integration of diverse data sets. Automation can reduce manual errors, accelerate the analysis process, and/or allow for more frequent updates, ensuring the model reflects real-time conditions.
5. Create intuitive visualizations and dashboards that present integrated insights in a user-friendly manner. This can enable stakeholders to quickly grasp the interconnectedness of demand, resources, and processes, facilitating data-driven decision-making.
6. Implement real-time monitoring of underpinning metrics that continuously track key performance indicators related to resource availability, capability, and process efficiency. This may ensure that any deviations from predicted demand are promptly identified.
7. Establish a culture of continuous improvement and collaboration, where feedback from operational experiences and market changes is used to refine the integration model. Review and update the model frequently to ensure it remains aligned with the evolving business landscape.

By performing at least one, or a combination, of these processing options, system 100 can compute a baseline productivity basis, resource capability, and/or available resource hours from the outputs. System 100 can further fine-tune the productivity determination by applying the process capability output.

At 704, system 100 may determine whether a gap exists between projected demand and process ability to service the demand as integrated at 702. For example, if the productivity, capability, and resource availability from processing at 704 are not adequate to cover the projected demand as determined above, system 100 can determine that there is a gap. This may be identified by a simple comparison of values and/or by more complex processing.

If a gap exists as determined at 704, at 706, system 100 may determine resource changes that may be applicable to close the gap. For example, system 100 may receive historical resource supply data and/or data about other resources that may be accessible to the resource provider but not currently being applied. System 100 may apply the resource capability index described above and determine the baseline productivity from the historical and/or accessible resources (i.e., the “fungible resources”) using inputs from process and resource capability determinations for those fungible resources. In like fashion to the above-described processing, system 100 can apply correction to the resource capability index based on external and/or internal factors influencing resource capability.

At 708, system 100 may run one or more of the first, second, third, and fourth ML models to forecast resource capabilities based on the changes determined at 706 as described above. From the outcome of this round of ML model processing, system 100 can determine whether a gap still exists. That is, system 100 can determine whether applying fungible resources closes the gap or if a gap remains even after the fungible resources are applied. If a gap remains, system 100 may repeat processing at 706 and 708 with additional and/or different fungible resources.

If no gap exists as determined at 704, or if the gap has been closed by processing at 706-708, at 710, system 100 may grade internal and external factors influencing supply and/or demand. The parameters used in grading may vary depending on the nature of the service being provided and/or specific aspects of the supply and/or demand. In at least some embodiments, system 100 may use one or more of the following grades and associated characteristics:

### High Risk:

Severe shortages in resource availability or capability.
Critical bottlenecks in processes.
Immediate attention and intervention are essential.
Implement emergency measures to secure resources.
Activate contingency plans to address process bottlenecks.
Significant negative impact on meeting customer demand.
Potential for customer dissatisfaction and order fulfillment delays.

### Medium Risk:

Moderate imbalances in resource availability or capability.
Process inefficiencies that can be addressed with proactive measures.
Develop and implement corrective strategies.
Allocate additional resources or adjust processes.
Monitor closely for potential escalation to high risk.
Noticeable impact on efficiency but not critical.
Potential for delays if not addressed promptly.

### Low Risk:

Minor discrepancies in resource levels or process efficiency.
Issues that can be managed without significant disruption.
Plan gradual improvements.
Implement continuous optimization measures.
Regularly monitor and reassess.
Limited impact on overall capability.
Room for improvement but not urgent.

### Balanced Process:

Resource levels and process efficiency closely aligned with predicted demand.
Optimal utilization of available resources.
Continue monitoring to sustain alignment.
Focus on maintaining efficiency and flexibility.
Smooth operations with minimal discrepancies.
Capacity to meet customer demand without strain.

### Surplus Supply:

Resources and capabilities exceed predicted demand.
Opportunities for cost optimization.
Explore cost-cutting measures without compromising quality.
Consider strategic resource reallocation.
Potential for increased profitability.
Capacity exceeds immediate demand, allowing for strategic decisions.

System 100 may employ a composite index system that combines both quantitative metrics and qualitative indicators. Each factor can be weighed based on its significance to overall business capability. Alternatively or additionally, system 100 may implement an adaptive grading system that evolves based on the evolving business landscape including product dynamic, business environment, etc.

At 712, system 100 may run the fifth ML model (e.g., integration model 150) to predict risk. System 100 may use ensemble methods and/or Bayesian statistical models to predict an accurate gap between resource availability, resource capability, and process capability against predicted customer demand. For example, system 100 may use one or more of the following as integration model 160:
Random Forest: Each tree is may be on a subset of the data (e.g., resource availability, resource, and process capability), and the final prediction may be an aggregate of individual tree predictions.
   Gradient Boosting builds a series of weak predictive models sequentially, with each model focused on correcting errors made by the previous ones. For example, if the resource availability predictions are weak, the model can apply corrections whilst predicting resource capability.
   Bayesian Statistical Models can incorporate probabilistic relationships between resource availability, capability, process efficiency, and customer demand. Further, Bayesian Networks may allow for the incorporation of domain knowledge and expert opinions.
   Multilayer Perceptron (MLP) can capture complex non-linear relationships across resource factors, process capabilities, and historical demand patterns to predict the gap accurately.

At 714, system 100 may determine whether the output of the fifth ML model indicates any anomalous trends. Once the model is run, system 100 may fine tune the predictions. This activity may include aligning the grades, reviewing outlier trends, etc. For example, system 100 can predict grades and/or gaps using the model and then compare how the actual data came in during a given time period. This method can help validate the model if the factors are calibrated. If there is a lack of alignment between model projections and real data, processing may proceed to 716.

At 716, system 100 may train the fifth ML model to correct anomalous performance as determined at 714. In some embodiments, training the fifth ML model may include performing processing comprising collecting fifth training data indicative of at least one grade and/or gap (or using the data collected as described above), creating fifth ML input training data by transforming at least a portion of the fifth training data as necessary, dividing the fifth ML input training data into a training set and a testing set, training the fifth ML model on the training set, and testing the fifth ML model by processing the testing set with the fifth ML model. After retraining, system 100 can perform processing at 712 to run the retrained model and processing at 714 to check the retrained model.

At 718, system 100 may grade and report the projected risk and/or implement changes to ensure the service can meet the demand. For example, if no anomalous trends are identified at 714 and/or if such anomalous trends are corrected by retraining at 716 followed by re-running the model, system 100 can report the output of fifth ML model processing, and/or such output may be used by system 100 to implement changes to the service that has been analyzed as described above.

As described above, system 100 may have already predicted the gap between customer demand and supply based on resource availability, resource capability and process capability. System 100 may narrate the contributors of the gap which ultimately led to the predicted grades. This narration of contributors can allow stakeholders to comprehend the dynamics influencing a business's capability to meet customer demand. By providing a transparent and comprehensive explanation, system 100 can provide stakeholders with insights into the factors shaping the forecast grades, fostering informed decision-making and strategic planning.

System 100 may be configured to produce a clear narrative to facilitate collaboration among various organizational functions. For example, if the narration advises gaps because of resource capability, a clear narrative may make it easier for the business to explain this trend to their HR counterparts. HR can use this information to better shape training and recruitment strategies. Similarly, such feedback within a factory scenario can help the tooling specialists as well as machine manufacturers to continuously improve their offering. It can encourage a shared understanding of challenges and opportunities, fostering a more cohesive and adaptive business environment. In essence, the narrative behind predicted grades can serve as a guiding framework, enabling stakeholders to proactively address potential gaps and capitalize on strengths, thereby ensuring a more robust and responsive business model aligned with customer needs.

System 100 may use the metrics to predict customer demand, resource availability, resource capability, and process capability derived as described above to generate a narrative. To produce the narrative, system 100 may perform one or more of the following actions in some embodiments:
1. Begin by quantifying the gap between customer demand and business capability. Use numerical data, charts, or graphs to illustrate the magnitude of the difference, providing stakeholders with a visual representation of the challenges. Explain how these factors influence the overall demand pattern and set the context for the analysis.
   2. Break down the available resources, including manpower, technology, and raw materials. Identify any shortages/surplus and explain how these variations impact the organization's ability to respond to customer demand.
   3. Assess the skills, expertise, and competence of the workforce. Discuss any gaps in training or skills that may hinder optimal resource utilization, affecting the organization's responsiveness to customer needs.
   4. Analyze the efficiency and effectiveness of operational processes. Identify bottlenecks, inefficiencies, or outdated procedures that contribute to the gap between what the customer demands and what the organization can deliver.
   5. Prioritize the key contributors to the gap based on their impact and feasibility for improvement. This can help stakeholders focus on the most critical aspects that require immediate attention.
   6. Offer a narrative that contextualizes the identified contributors. Explain the root causes behind each factor, linking them to broader industry trends, internal policies, or external factors that contribute to the observed gaps.

This can establish a common language for stakeholders. Ranking the correlation strength of each individual characteristic against predicted output can help identify critical factors across predicted customer demand, resource availability, resource capability and process capability.

FIGS. 8A-8G show example narration reports according to some embodiments of the disclosure. System 100 may generate such reports and present them to a user, for example through a graphical user interface. The respective figures show respective reports on individual topics separately, but it will be appreciated that reports may be combined within a user interface, split into sub-reports, and/or otherwise arranged differently from the illustrated examples. Also, sample data is shown, but it will be understood that system 100 is not limited to generating reports containing the illustrated sample data.

FIG. 8A shows an example customer demand report 800. Customer demand report 800 may include graphics, text, and/or other media components that may be used separately or in combination to report one or more customer demand results. Customer demand results may include, but are not limited to, outputs of process 300 described above. In the illustrated example, customer demand report 800 includes historical customer demand information 802, information about customer demand factors 804, and predicted customer demand information 806.

FIG. 8B shows an example customer demand grade report 810. Customer demand grade report 810 may include graphics, text, and/or other media components that may be used separately or in combination to report one or more customer demand grading results. Customer demand grading results may include, but are not limited to, outputs of process 300 described above. In the illustrated example, customer demand grade report 810 includes predicted customer demand information 812, customer demand grading factors 814, and expanded customer demand projection information 816.

FIG. 8C shows an example resource availability report 820. Resource availability report 820 may include graphics, text, and/or other media components that may be used separately or in combination to report one or more resource availability results. Resource availability results may include, but are not limited to, outputs of process 400 described above. In the illustrated example, resource availability report 820 includes historical resource availability information 822, information about resource availability factors 824, and predicted resource availability information 826.

FIG. 8D shows an example resource capability report 830. Resource capability report 830 may include graphics, text, and/or other media components that may be used separately or in combination to report one or more resource capability results. Resource capability results may include, but are not limited to, outputs of process 500 described above. In the illustrated example, resource capability report 830 includes historical resource capability information 832, information about resource capability factors 834, resource capability grading information 836, and predicted resource capability information 838.

FIG. 8E shows an example process capability report 840. Process capability report 840 may include graphics, text, and/or other media components that may be used separately or in combination to report one or more process capability results. Process capability results may include, but are not limited to, outputs of process 600 described above. In the illustrated example, process capability report 840 includes historical process capability information 842, information about process capability factors 844, process capability grading information 846, and predicted process capability information 848.

FIG. 8F shows an example consolidated report 850. Consolidated report 850 may include graphics, text, and/or other media components that may be used separately or in combination to report on the consolidated analysis of customer demand, resource availability, resource capability, and/or process capability. Consolidated results may include, but are not limited to, outputs of process 700 described above and/or inputs thereto (e.g., outputs of process 300, 400, 500, and/or 600). In the illustrated example, consolidated report 850 includes consolidated factor heatmap 852 and information about demand vs. supply trends in various upcoming time frames 854, 856, 858.

FIG. 8G shows an example explanation/narration report 860. Explanation/narration report 860 may include graphics, text, and/or other media components that may be used separately or in combination to provide a detailed description and/or narration of the consolidated analysis of customer demand, resource availability, resource capability, and/or process capability. Consolidated results may include, but are not limited to, outputs of process 700 described above and/or inputs thereto (e.g., outputs of process 300, 400, 500, and/or 600). Narration information may be generated by system 100 using a large language model and/or other text generation technology based on the consolidated results as prompts or inputs. In the illustrated example, explanation/narration report 860 includes customer demand factor information 862, resource availability factor information 864, process capability factor information 866, quality of demand factor information 868, resource capability factor information 870, consolidated factor heatmap 872, and/or narration 874.

Based on the outcome of process 700 and/or reporting as shown in FIGS. 8A-8G, system 100 may automatically perform and/or may recommend one or more interventions to bring resources in line with projected demand. The specific nature of these interventions may depend upon the service in question, but in general, such interventions may include provisioning resources (e.g., fungible resources described above) for the service. The following are some examples of interventions that may apply to given example situations.

If the above-described processing reveals a severe gap in resource availability or capacity against demand (e.g., where “severe” is defined as being above some threshold level of gap), system 100 may determine that immediate attention and intervention should be applied. This may include implementing emergency measures to secure resources, activating contingency plans to address process bottlenecks, generating and/or sending communications to users or other entities to indicate possible impact on meeting customer demand and/or business/reputational impact, and/or tracking performance and/or system availability in real time or near real time, for example.

If the above-described processing reveals a noticeable gap in resource availability or capacity against demand (e.g., where “noticeable” is defined as being above below the “severe” threshold level of gap but above another, lower threshold level of gap), system 100 may determine that proactive measures should be applied to address process inefficiencies. This may include developing and/or implementing corrective strategies, allocating additional resources, adjusting processes, tracking performance and/or system availability, monitoring for potential escalation to a “severe” level of risk, and/or generating and/or sending communications to users or other entities to indicate possible impact on meeting customer demand and/or business/reputational impact (e.g., if gaps persist), for example.

If the above-described processing reveals a minor gap in resource availability or capacity against demand (e.g., where “minor” is defined as being above below the lower threshold level of gap for “noticeable” but not zero or substantially non-existent), system 100 may determine that gradual and/or minor improvements should be implemented. This may include applying improvements around systems and/or processes, recommending and/or applying improvements around people and/or procedures, implementing optimization measures, and/or regularly or occasionally monitoring and/or reassessing supply, for example.

If the above-described processing reveals that resource levels and process efficiency are closely aligned with predicted demand, such that unforeseen incidents may cause gaps, system 100 may perform monitoring to sustain alignment, perform processing to maintain efficiency and/or flexibility, and/or perform processing to recommend and/or implement automation and/or reengineering to prevent or reduce unplanned resource consumption, for example.

If the above-described processing reveals that resources and/or capabilities exceed those needed to service predicted demand, system 100 may identify and recommend opportunities for cost optimization, process optimization measures that can reduce cost without compromising quality, strategic resource reallocation, and/or opportunities to expand service to other customers and/or applications, for example.

As described above, system 100 may use one or a plurality of ML models to perform the disclosed processing. Accordingly, building the ML models can be a part of provisioning system 100. Building a model to predict a service's capability to service customers may involve a systematic and structured approach. To that end, the following preparation may be applied when building a model in at least some embodiments.

System 100 may define an objective or objectives before building a model. It may be helpful to know the business and/or service challenge to be solved with this model. Objective clarification may involve clearly defining the purpose and desired outcomes of the model. For instance, in predicting a business's capability to service customers, the objective may be to create a model that accurately forecasts the organization's proficiency in meeting customer needs. A specific goal might be to achieve a predictive accuracy of 90%, ensuring the model aligns with broader business strategies aimed at enhancing customer satisfaction and loyalty. By articulating clear objectives, stakeholders gain a shared understanding of the model's intended impact, fostering focused development and measurable success criteria.

System 100 may define a metric or metrics to achieve the objective(s). It may be helpful to translate the business objective into a measurable metric. This could be a composite score based on various KPIs or an outcome indicating high/medium/low or yes/no capability, for example. This metric can represent the outcome the model aims to predict. An example metric in predicting servicing capability could be a composite customer service score derived from metrics like response times, satisfaction scores, and issue resolution rates or even any one of these metrics. Alternatively, a metric might be a variable indicating high, medium, or low service capability based on a predefined threshold. For instance, if the composite score exceeds 80%, the metric could be “High Capability,” while scores below could indicate “Low Capability.” Defining the metric with clarity can align the model's focus with the specific business objective of assessing customer service performance.

Considerations in defining the metric may include, but are not limited to, the following. Checking the distribution of the metric may ensure there is a reasonable balance between the classes (e.g., satisfactory and unsatisfactory) to avoid model bias. Validating the metric against known business logic and dynamics may, for example, ensure that instances marked as ‘satisfactory’ align with scenarios where customers are likely to be satisfied based on established business rules. Examining how well the metric correlates with broader business metrics, for example in a customer satisfaction metric checking whether instances marked as ‘satisfactory’ align with positive customer feedback or repeat business. Seeking input from domain experts or stakeholders to validate the target variable may provide valuable feedback on whether the target variable captures the essence of the business objective (e.g., domain experts may validate whether the chosen threshold aligns with their understanding of what constitutes a positive or negative outcome in customer satisfaction). If the model is too lenient or too strict in categorizing outcomes, adjusting the threshold for the target variable may be performed to reflect the business's tolerance for false positives and false negatives.

System 100 may identify one or more factors influencing the objective, which may include identifying and/or prioritizing the factors that influence the outlined business objectives. As mentioned above, one or more factors may influence the objective. While factor identification is a conceptual step that involves selecting relevant variables, the algorithmic implementation may involve statistical methods or data-driven approaches. For example, some embodiments may use one or more feature selection algorithms.

System 100 may perform data collection of the ascertained factors, which may enable measurement of the factors reliably and consistently. Data sources refer to the origin of information used to train and test the model. For predicting a business's customer service capability, sources may include, but are not limited to, customer feedback surveys, employee training records, and/or service logs. For instance, customer feedback may be collected through online surveys, providing sentiment analysis data. Employee training records can be sourced from HR databases, offering insights into staff proficiency. Service logs, retrieved from customer interactions, may contain valuable data on response times and issue resolutions. By integrating diverse data sources, the model may gain a comprehensive understanding of the factors influencing customer service performance, enhancing prediction accuracy.

System 100 may check data quality of the target metric and ascertained factors. Ensuring data quality may enable development of a reliable model. For example, for each metric, system 100 may conduct checks for completeness, accuracy, and/or consistency. For example, in customer satisfaction scores, system 100 may check for missing or anomalous values, ensuring that responses cover the entire dataset. In service level agreements (SLAs), for example, system 100 may validate if the recorded times align with predefined benchmarks, identifying any outliers or discrepancies. Employee training records may be verified for completeness and accuracy, confirming that all relevant training sessions are documented correctly. These checks can help ensure that the data used to train the model is accurate and representative, enhancing the model's predictive capabilities.

In at least some embodiments, validation may be an iterative process. Revisiting the validation steps periodically may be helpful because the model can evolve as more feedback is received from users and stakeholders. System 100 may adjust the metric definition or model parameters accordingly.

System 100 may document and/or communicate the rationale behind the chosen metric definition and the results of the validation process. System 100 may communicate this information clearly to stakeholders, ensuring a shared understanding of how the model aligns with the overall business objective. System 100 may present the results to stakeholders and gather feedback. If the model's predictions resonate with stakeholder expectations and business goals, this may indicate compatibility with the overall objective. System 100 may clearly document the decisions made regarding the target variable definition, including any adjustments based on testing. System 100 may communicate these decisions to stakeholders for transparency and alignment.

As discussed above, at least some embodiments described herein may continuously improve and/or monitor model performance through retraining, retuning, and/or adapting ML models. The following considerations may guide system 100 and/or operators thereof in performing such continuous improvement and/or monitoring.

Continuous improvement and/or monitoring can help maintain model effectiveness and ethical standards. In the dynamic landscape of many use cases, such as the financial industry as one non-limiting example, market conditions, customer behaviors, and/or regulatory environments are subject to frequent changes. Kaizen, a Japanese term meaning “continuous improvement,” is a philosophy and methodology focused on incremental and continuous improvements in processes and operations. When applied to predictive models, Kaizen principles can enhance the model's performance, adaptability, and reliability over time. The following are some such principles that may be observed by system 100.

In some embodiments, system 100 may regularly assess and improve the quality of input data. System 100 may continuously refine and enhance the data pre-processing pipeline to address issues like missing values, outliers, and data inconsistencies. This can ensure that the model is trained on high-quality data, leading to more accurate predictions.

In some embodiments, system 100 may iteratively optimize metrics engineering for efficiency. System 100 may regularly revisit and refine feature engineering techniques. System 100 may explore new features, transformations, or interactions to capture additional patterns in the data, improving the model's ability to make accurate predictions.

In some embodiments, system 100 may adjust parameters for continuous improvement. System 100 may regularly tune hyperparameters based on performance evaluations. System 100 may use techniques like grid search or randomized search to find optimal settings, ensuring the model adapts to changing data patterns and remains effective.

In some embodiments, system 100 may establish monitoring for ongoing assessment. System 100 may implement continuous monitoring of model performance in real-world scenarios. System 100 may regularly evaluate the model's predictions against actual outcomes and intervene when performance metrics deviate from established thresholds. This may ensure the model remains relevant and trustworthy.

In some embodiments, system 100 may encourage feedback for improvement. System 100 may foster a feedback loop between data scientists, business stakeholders, and end-users. System 100 may solicit insights, concerns, and suggestions for model improvement, creating a collaborative environment that drives continuous refinement.

In some embodiments, system 100 may adapt to dynamic environments. System 100 may ensure models are adaptable to changing market conditions, customer behaviors, or regulatory landscapes. System 100 may periodically retrain models with updated data to maintain relevance and accuracy in evolving scenarios.

In some embodiments, system 100 may document improvements for knowledge sharing. System 100 may maintain detailed documentation of model development, changes, and outcomes. System 100 may share this knowledge across the data science team and with stakeholders, facilitating collective learning and informed decision-making.

In some embodiments, system 100 may continuously address ethical considerations. System 100 may regularly evaluate models for biases and ethical implications. System 100 may implement strategies to mitigate biases, ensuring fair and responsible use of the model across diverse populations.

In some embodiments, system 100 may be part of an organization's culture of continuous improvement. Thus, system 100 may ensure that models remain effective, ethical, and aligned with evolving business needs and challenges.

In the above-described embodiments, ethical considerations in using data for predictive models can be applied to ensure responsible and fair use of data, particularly in sensitive domains such as finance. For example, protecting individuals' privacy is paramount, so embodiments described herein may include safeguards ensuring that personally identifiable information (PII) is handled with the utmost care and is anonymized or pseudonymized whenever possible. Some actions system 100 may employ can include, but are not limited to, implementing strong data encryption methods, adhering to privacy regulations such as GDPR, HIPAA, and/or other applicable laws, and clearly communicating data usage policies to users.

As another example, models used in the above-described embodiments can be configured to be fair and unbiased, avoiding discrimination based on race, gender, ethnicity, or other protected characteristics. Some actions system 100 may employ can include, but are not limited to, regularly auditing and assessing models for biases, addressing bias in both data and algorithms, and/or striving for diverse and representative training datasets.

As another example, stakeholders should understand how models used in the described embodiments make decisions to maintain trust and accountability. Some actions system 100 may employ can include, but are not limited to, using interpretable models and/or providing explanations for complex models, documenting model development and decision-making processes, and/or providing information about limitations and uncertainties.

Some embodiments may require informed consent when collecting and using personal data for predictive modeling. Some actions system 100 may employ can include, but are not limited to, clearly communicating the purpose and scope of data usage and/or allowing users to opt-in or opt-out of data collection and processing.

In some embodiments, roles and responsibilities for handling data and accountability for model performance may be clearly defined. Some actions system 100 may employ can include, but are not limited to, designating responsible individuals or teams for data governance, regularly reviewing and updating ethical guidelines and policies, and/or establishing protocols for handling ethical concerns.

As another example, some embodiments may ensure that data used for training and testing models is accurate and representative to prevent unintentional biases. Some actions system 100 may employ can include, but are not limited to, implementing data quality checks and validation processes, addressing missing or erroneous data through appropriate techniques, and/or continuously monitoring and updating data quality.

Some embodiments may adhere to relevant laws and regulations governing data use, such as financial regulations, privacy laws, and anti-discrimination laws. Some actions system 100 may employ can include, but are not limited to, staying informed about evolving regulations, conducting regular compliance audits, and/or collaborating with legal experts to ensure adherence.

In another example, embodiments may involve stakeholders and the community in decision-making processes to foster inclusivity and consider diverse perspectives. Some actions system 100 may employ can include, but are not limited to, soliciting feedback from affected communities, establishing advisory boards for ethical considerations, and/or engaging in open dialogue with stakeholders.

Some embodiments may regularly monitor model performance and ethical implications after deployment. Some actions system 100 may employ can include, but are not limited to, implementing monitoring tools for real-time assessment, establishing protocols for addressing issues as they arise, and/or periodically re-evaluating ethical considerations as technology evolves.

By integrating these ethical considerations into the entire life cycle of predictive modeling, organizations can develop models that not only perform well but also adhere to ethical standards, ensuring responsible and fair use of data in any sensitive context.

FIG. 9 shows a computing device 900 according to some embodiments of the disclosure. For example, computing device 900 may function as system 100 and/or any portion(s) thereof, or multiple computing devices 900 may function as system 100 and/or any portion(s) thereof.

Computing device 900 may be implemented on any electronic device that runs software applications derived from compiled instructions, including without limitation personal computers, servers, smart phones, media players, electronic tablets, game consoles, email devices, etc. In some implementations, computing device 900 may include one or more processors 902, one or more input devices 904, one or more display devices 906, one or more network interfaces 908, and one or more computer-readable mediums 910. Each of these components may be coupled by bus 912, and in some embodiments, these components may be distributed among multiple physical locations and coupled by a network.

Display device 906 may be any known display technology, including but not limited to display devices using Liquid Crystal Display (LCD) or Light Emitting Diode (LED) technology. Processor(s) 902 may use any known processor technology, including but not limited to graphics processors and multi-core processors. Input device 904 may be any known input device technology, including but not limited to a keyboard (including a virtual keyboard), mouse, track ball, and touch-sensitive pad or display. Bus 912 may be any known internal or external bus technology, including but not limited to ISA, EISA, PCI, PCI Express, NuBus, USB, Serial ATA or Fire Wire. In some embodiments, some or all devices shown as coupled by bus 912 may not be coupled to one another by a physical bus, but by a network connection, for example. Computer-readable medium 910 may be any medium that participates in providing instructions to processor(s) 902 for execution, including without limitation, non-volatile storage media (e.g., optical disks, magnetic disks, flash drives, etc.), or volatile media (e.g., SDRAM, ROM, etc.).

Computer-readable medium 910 may include various instructions 914 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 904; sending output to display device 906; keeping track of files and directories on computer-readable medium 910; controlling peripheral devices (e.g., disk drives, printers, etc.) which can be controlled directly or through an I/O controller; and managing traffic on bus 912. Network communications instructions 916 may establish and maintain network connections (e.g., software for implementing communication protocols, such as TCP/IP, HTTP, Ethernet, telephony, etc.).

System 100 component(s) 918 may include instructions for performing the processing described herein. For example, system 100 component(s) 918 may provide instructions for performing any and/or all of processes 200, 300, 400, 500, 600, and/or 700 as described above. Application(s) 920 may be an application that uses or implements the outcome of processes described herein and/or other processes. In some embodiments, the various processes may also be implemented in operating system 914.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
predicting, by at least one processor, a customer demand for a resource using a first machine learning (ML) model;
predicting, by the at least one processor, a resource availability for the resource using a second ML model;
predicting, by the at least one processor, a resource capability for the resource using a third ML model;
predicting, by the at least one processor, a process capability for the resource using a fourth ML model;
determining, by the at least one processor, a gap between the customer demand and a resource ability to meet the customer demand exists due to a combination of the resource availability, the resource capability, and the process capability; and
adjusting, by the at least one processor, at least one resource parameter to reduce or eliminate the gap.

2. The method of claim 1, wherein the predicting the customer demand comprises:
collecting, by the at least one processor, first data indicative of at least one customer trait;
creating, by the at least one processor, first ML input data by transforming at least a portion of the first data; and
processing, by the at least one processor, the first ML input data with the first ML model.

3. The method of claim 2, wherein the predicting the customer demand further comprises:
evaluating, by the at least one processor, a quality of the first data; and
adjusting, by the at least one processor, an output of the processing of the first ML model according to the quality.

4. The method of claim 1, further comprising training the first ML model by performing processing comprising:
collecting, by the at least one processor, first training data indicative of at least one customer trait;
creating, by the at least one processor, first ML input training data by transforming at least a portion of the first training data;
dividing, by the at least one processor, the first ML input training data into a training set and a testing set;
training, by the at least one processor, the first ML model on the training set; and
testing, by the at least one processor, the first ML model by processing the testing set with the first ML model.

5. The method of claim 1, wherein the predicting the resource availability comprises:
collecting, by the at least one processor, second data indicative of at least one resource characteristic;
evaluating, by the at least one processor, a quality of the second data;
selecting, by the at least one processor, a statistical model according to the quality as the second ML model; and
processing, by the at least one processor, the second data with the second ML model.

6. The method of claim 1, wherein the predicting the resource capability comprises:
collecting, by the at least one processor, intrinsic third data indicative of at least one intrinsic resource characteristic;
collecting, by the at least one processor, extrinsic third data indicative of at least one extrinsic resource characteristic;
evaluating, by the at least one processor, a quality of the intrinsic third data and the extrinsic third data;
selecting, by the at least one processor, a statistical model according to the quality as the third ML model; and
processing, by the at least one processor, the intrinsic third data and the extrinsic third data with the third ML model.

7. The method of claim 1, wherein the predicting the process capability comprises:
collecting, by the at least one processor, fourth data indicative of at least one process characteristic;
evaluating, by the at least one processor, a quality of the fourth data;
selecting, by the at least one processor, a statistical model according to the quality as the fourth ML model; and
processing, by the at least one processor, the fourth data with the fourth ML model.

8. The method of claim 1, wherein the determining the gap comprises processing, by the at least one processor, the resource availability, the resource capability, and the process capability with a fifth ML model.

9. The method of claim 1, wherein the adjusting comprises increasing a number of components assigned to the resource.

10. The method of claim 1, wherein the adjusting comprises reporting an explanation of the gap.

11. A system comprising:
at least one processor; and
at least one non-transitory memory in communication with the at least one processor and storing instructions that, when executed by the at least one processor, cause the at least one processor to perform processing comprising:
predicting a customer demand for a resource using a first machine learning (ML) model;
predicting a resource availability for the resource using a second ML model;
predicting a resource capability for the resource using a third ML model;
predicting a process capability for the resource using a fourth ML model;
determining a gap between the customer demand and a resource ability to meet the customer demand exists due to a combination of the resource availability, the resource capability, and the process capability; and
adjusting at least one resource parameter to reduce or eliminate the gap.

12. The system of claim 11, wherein the predicting the customer demand comprises:
collecting first data indicative of at least one customer trait;
creating first ML input data by transforming at least a portion of the first data; and
processing the first ML input data with the first ML model.

13. The system of claim 12, wherein the predicting the customer demand further comprises:
evaluating a quality of the first data; and
adjusting an output of the processing of the first ML model according to the quality.

14. The system of claim 11, wherein the processing further comprises training the first ML model by performing processing comprising:
collecting first training data indicative of at least one customer trait;
creating first ML input training data by transforming at least a portion of the first training data;
dividing the first ML input training data into a training set and a testing set;
training the first ML model on the training set; and
testing the first ML model by processing the testing set with the first ML model.

15. The system of claim 11, wherein the predicting the resource availability comprises:
collecting second data indicative of at least one resource characteristic;
evaluating a quality of the second data;
selecting, a statistical model according to the quality as the second ML model; and
processing the second data with the second ML model.

16. The system of claim 11, wherein the predicting the resource capability comprises:
collecting intrinsic third data indicative of at least one intrinsic resource characteristic;
collecting extrinsic third data indicative of at least one extrinsic resource characteristic;
evaluating a quality of the intrinsic third data and the extrinsic third data;
selecting a statistical model according to the quality as the third ML model; and
processing the intrinsic third data and the extrinsic third data with the third ML model.

17. The system of claim 11, wherein the predicting the process capability comprises:
collecting fourth data indicative of at least one process characteristic;
evaluating a quality of the fourth data;
selecting a statistical model according to the quality as the fourth ML model; and
processing the fourth data with the fourth ML model.

18. The system of claim 11, wherein the determining the gap comprises processing the resource availability, the resource capability, and the process capability with a fifth ML model.

19. The system of claim 11, wherein the adjusting comprises increasing a number of components assigned to the resource.

20. The method of claim 1, wherein the adjusting comprises reporting an explanation of the gap.
